(19) United States
(12) Patent Application Publication
(10) Pub. No.: US 2016/0283621 A1
(43) Pub. Date: Sep. 29, 2016

(54) Hybrid Simulation Methodologies

(71) Applicant: SAS Institute Inc., Cary, NC (US)

(72) Inventors: Zhiping Yang, Cary, NC (US); Donald James Erdman, Raleigh, NC (US); Stacey Michelle Christian, Cary, NC (US); Wei Chen, Apex, NC (US)

(73) Assignee: SAS Institute Inc., Cary, NC (US)

(21) Appl. No.: 15/055,242

(22) Filed: Feb. 26, 2016

Related U.S. Application Data
(63) Continuation-in-part of application No. 12/683,020, filed on Jan. 6, 2010, now abandoned.

(51) Int. Cl. G06F 17/50; G06F 17/18

(52) U.S. Cl. CPC G06F 17/5009; G06F 17/18

(57) ABSTRACT

Possible outcomes can be determined by combining simulation methods on a pool of input variables. Certain members of the pool are identified as members of a first set of variables (e.g., priority set), and certain other members of the pool of input variables are identified as members of a second set of variables (e.g., non-priority set). A first set of possible values for the first set of variables can be generated by applying a first simulation method. A second set of possible values for the second set of variables can be generated by applying a second simulation method that differs from the first simulation method in various ways, such as accuracy, completion time, and computational expense. A copula data structure can be used to maintain correlations between the variables of the pool of input variables when generating a hybrid set of simulated values based on the first and second simulation.

### CROSS REFERENCE TO RELATED APPLICATIONS

This application is a continuation in part of U.S. patent application Ser. No. 12/683,020 filed Jan. 6, 2010, entitled “Hybrid Simulation Methodologies to Simulate Risk Factors.”

### TECHNICAL FIELD

The technology described herein relates generally to computing systems and more specifically to the application of different simulation techniques to different risk factors in a single simulation.

### BACKGROUND

Computing systems can be used to model environments, to determine possible outcomes or values based on a set of variables and a selected simulation technique. Variables can have different attributes and behaviors and can be unique contributors to the entire environment. The variables may often be modeled as a correlated system.

The performance of a computing system can be limited by various constraints, such as processing power, available time to process, available storage, available operating memory, available bandwidth, or other constraints. The accuracy of possible outcomes (e.g., possible values) can depend greatly on the simulation method used. From a technical point view, each method has one or more, but not all, of these advantages: high accuracy; easy specification; and fast computation. Unfortunately each also suffers from one or more of the following drawbacks: inaccuracy, difficult specification, and slow computation. Traditionally, because of the importance of the correlation between variables, only a single simulation method was used for all variables in single application. While highly-accurate methods may be desirable in certain circumstances, they may be unavailable due to the high costs involved, such as costs associated with time and processing power. Thus, the choice of a method may be limited based on computing systems employed.

### SUMMARY

A computer-implemented system is disclosed, comprising one or more data processors and one or more non transitory computer-readable storage media containing instructions configured to cause the one or more processors to perform operations including accessing past data including multiple variables, wherein the one or more data processors include a hybrid simulation engine; automatically identifying a priority set of variables, wherein the priority set includes one or more of the multiple variables having a first degree of information contribution; automatically identifying a non-priority set of variables, wherein the non-priority set includes one or more of the multiple variables having a second degree of information contribution that is lesser than the first degree of information contribution; producing a copula data structure using the past data, wherein the copula data structure is used to maintain correlations among the multiple variables, and wherein producing the copula data structure includes performing a copula calculation using the past data; calculating a set of priority simulated values for one or more variables of the priority set, wherein calculating includes using a first simulation technique and the copula data structure, and wherein the first simulation technique results in a first computational expense to the one or more data processors processing the one or more variables of the priority set; calculating a set of non-priority simulated values for one or more variables of the non-priority set, wherein calculating includes using a second simulation technique and the copula data structure, wherein the second simulation technique results in a second computational expense to the one or more data processors processing the one or more variables of the non-priority set, and wherein the second computational expense to the one or more data processors is less than the first computational expense to the one or more data processors; and producing a hybrid set of simulated values for the multiple variables using the hybrid simulation engine, wherein the hybrid simulation engine processes the priority simulated values and the non-priority simulated values on the hybrid simulation engine, and wherein producing the hybrid set of simulated values for the multiple variables concurrently prioritizes accuracy of the priority simulated values and reduces an overall computational expense to the one or more data processors.

A computer-implemented method is disclosed, comprising accessing, on a computing device, past data including multiple variables, wherein the computing device includes a hybrid simulation engine for producing hybrid forecasts using one or one or more data processors of the computing device; automatically identifying a priority set of variables, wherein the priority set includes one or more of the multiple variables having a first degree of information contribution; automatically identifying a non-priority set of variables, wherein the non-priority set includes one or more of the multiple variables having a second degree of information contribution that is lesser than the first degree of information contribution; producing a copula data structure using the past data, wherein the copula data structure is used to maintain correlations among the multiple variables, and wherein producing the copula data structure includes performing a copula calculation using the past data; calculating a set of priority simulated values for one or more variables of the priority set, wherein calculating includes using a first simulation technique and the copula data structure, and wherein the first simulation technique results in a first computational expense to the one or more data processors processing the one or more variables of the priority set; calculating a set of non-priority simulated values for one or more variables of the non-priority set, wherein calculating includes using a second simulation technique and the copula data structure, wherein the second simulation technique results in a second computational expense to the one or more data processors processing the one or more variables of the non-priority set, and wherein the second computational expense to the one or more data processors is less than the first computational expense to the one or more data processors; and producing a hybrid set of simulated values for the multiple variables using the hybrid simulation engine, wherein the hybrid simulation engine processes the priority simulated values and the non-priority simulated values on the hybrid simulation engine, and wherein producing the hybrid set of simulated values for the multiple variables concurrently prioritizes accuracy of the priority simulated values and reduces an overall computational expense to the one or more data processors.

A computer-program product tangibly embodied in a non-transitory machine-readable storage medium is disclosed, including instructions configured to cause a data processing apparatus to perform operations including accessing past data including multiple variables, wherein the data processing apparatus includes a hybrid simulation engine for producing hybrid forecasts using one or more data processors of the data processing apparatus; automatically identifying a priority set of variables, wherein the priority set includes one or more of the multiple variables having a first degree of information contribution; automatically identifying a non-priority set of variables, wherein the non-priority set includes one or more of the multiple variables having a second degree of information contribution that is lesser than the first degree of information contribution; producing a copula data structure using the past data, wherein the copula data structure is used to maintain correlations among the multiple variables, and wherein producing the copula data structure includes performing a copula calculation using the past data; calculating a set of priority simulated values for one or more variables of the priority set, wherein calculating includes using a first simulation technique and the copula data structure, and wherein the first simulation technique results in a first computational expense to the one or more data processors processing the one or more variables of the priority set; calculating a set of non-priority simulated values for one or more variables of the non-priority set, wherein calculating includes using a second simulation technique and the copula data structure, wherein the second simulation technique results in a second computational expense to the one or more data processors processing the one or more variables of the non-priority set, and wherein the second computational expense to the one or more data processors is less than the first computational expense to the one or more data processors; and producing a hybrid set of simulated values for the multiple variables using the hybrid simulation engine, wherein the hybrid simulation engine processes the priority simulated values and the non-priority simulated values on the hybrid simulation engine, and wherein producing the hybrid set of simulated values for the multiple variables concurrently prioritizes accuracy of the priority simulated values and reduces an overall computational expense to the one or more data processors.

In certain aspects of the present disclosure, automatically identifying the priority set of variables can include calculating the information contribution of the one or more variables of the priority set and calculating the information contribution of the one or more variables of the non-priority set.

In certain aspects of the present disclosure, the first simulation technique includes a Monte Carlo simulation.

In certain aspects of the present disclosure, the second simulation technique includes a covariate simulation.

In certain aspects of the present disclosure, calculating a set of priority simulated values for one or more variables of the priority set further includes automatically selecting the set of priority simulated values based on the duration of an observation period corresponding to one or more of the variables of the priority set.

In certain aspects of the present disclosure, calculating a set of priority simulated values for one or more variables of the priority set further includes computing independent random vectors; converting the independent random vectors to a correlated set of uniforms using the copula data structure; and transforming the uniforms into marginal distributions.

In certain aspects of the present disclosure, converting the independent random vectors to a correlated set of uniforms involves utilizing a Cholesky factorization of a covariance matrix.

In certain aspects of the present disclosure, the past data associated with a variable of the priority set corresponds to a first observation period, and wherein the past data associated with a variable of the non-priority set corresponds to a second observation period, and wherein the second observation period is of a different duration than the first observation period.

In certain aspects of the present disclosure, automatically identifying the priority set of variables is based on an amount of past data associated with one or more individual variables.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

The present disclosure is described in conjunction with the appended figures:

FIG. 1 illustrates a block diagram that provides an illustration of the hardware components of a computing system, according to some embodiments of the present technology.

FIG. 2 illustrates an example network including an example set of devices communicating with each other over an exchange system and via a network, according to some embodiments of the present technology.

FIG. 3 illustrates a representation of a conceptual model of a communications protocol system, according to some embodiments of the present technology.

FIG. 4 illustrates a communications grid computing system including a variety of control and worker nodes, according to some embodiments of the present technology.

FIG. 5 illustrates a flow chart showing an example process for adjusting a communications grid or a work project in a communications grid after a failure of a node, according to some embodiments of the present technology.

FIG. 6 illustrates a portion of a communications grid computing system including a control node and a worker node, according to some embodiments of the present technology.

FIG. 7 illustrates a flow chart showing an example process for executing a data analysis or processing project, according to some embodiments of the present technology.

FIG. 8 illustrates a block diagram including components of an Event Stream Processing Engine (ESPE), according to embodiments of the present technology.

FIG. 9 illustrates a flow chart showing an example process including operations performed by an event stream processing engine, according to some embodiments of the present technology.

FIG. 10 illustrates an ESP system interfacing between a publishing device and multiple event subscribing devices, according to embodiments of the present technology.

FIG. 11 depicts a computer-implemented environment wherein users can interact with a hybrid simulation engine hosted on one or more servers through a network.

FIG. 12 is a block diagram depicting example inputs and outputs of a hybrid simulation engine.

FIG. 13 is a flow diagram depicting a hybrid simulation process.

FIG. 14 is a flow diagram depicting an automated identification of risk factor subgroups.

FIG. 15 is a flow diagram depicting a hybrid simulation process where the variable set identification is a manual process dictated by user input.

FIG. 16 is a flow diagram depicting a hybrid simulation engine that maintains correlations among risk factors in different subgroups using a copula.

FIG. 17 is a flow diagram depicting a generation of a simulated forecast using a hybrid simulation engine that utilizes a copula to maintain correlations among variables.

FIGS. 18, 19, and 20 depict example processing systems for use in implementing a hybrid simulation engine.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

In the following description, for the purposes of explanation, specific details are set forth in order to provide a thorough understanding of embodiments of the technology. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the example embodiments will provide those skilled in the art with an enabling description for implementing an example embodiment. It should be understood that various changes may be made in the function and arrangement of elements without departing from the spirit and scope of the technology as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional operations not included in a figure. A process may correspond to a method, a function, a procedure, a subroutine, a subprogram, etc. When a process corresponds to a function, its termination can correspond to a return of the function to the calling function or the main function.

Systems depicted in some of the figures may be provided in various configurations. In some embodiments, the systems may be configured as a distributed system where one or more components of the system are distributed across one or more networks in a cloud computing system.

Computer-implemented systems and methods are disclosed for determining possible outcomes (e.g., by generating a simulated forecast) based on a pool of input variables (e.g., risk factors). Certain members of the pool of input variables are identified as members of a first set of variables, and certain other members of the pool of input variables are identified as members of a second set of variables. A first simulation is generated via a first simulation method (e.g., simulation technique) using the first set of variables, and a second simulation is generated via a second simulation method that differs from the first simulation method using the second set of variables. The first simulation and the second simulation are generated using correlations among variables in the first set of variables and variables in the second set of variables.

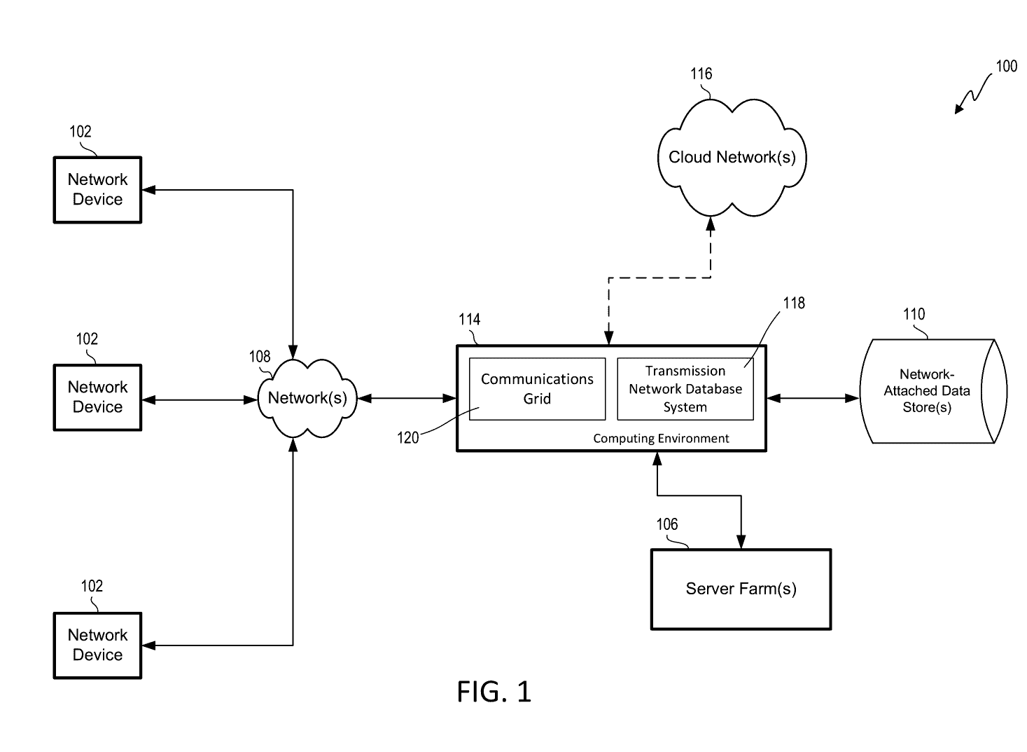

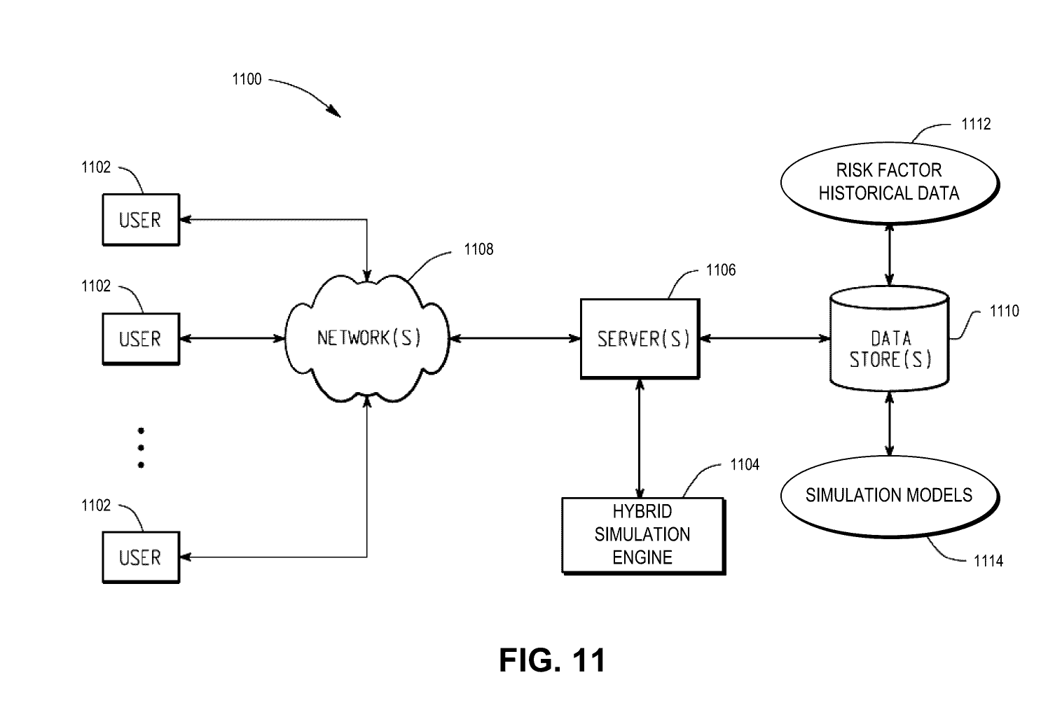

FIG. 1 is a block diagram that provides an illustration of the hardware components of a data transmission network 100, according to embodiments of the present technology. Data transmission network 100 is a specialized computer system that may be used for processing large amounts of data where a large number of computer processing cycles are required. Data transmission network 100 can be used with the various aspects of the disclosure, such as those disclosed in FIGS. 11-20, such as for storing, displaying, receiving, generating, or performing other tasks related to hybrid simulation as disclosed herein.

Data transmission network 100 may also include computing environment 114. Computing environment 114 may be a specialized computer or other machine that processes the data received within the data transmission network 100. Data transmission network 100 also includes one or more network devices 102. Network devices 102 may include client devices that attempt to communicate with computing environment 114. For example, network devices 102 may send data to the computing environment 114 to be processed, may send signals to the computing environment 114 to control different aspects of the computing environment or the data it is processing, among other reasons. Network devices 102 may interact with the computing environment 114 through a number of ways, such as, for example, over one or more networks 108. As shown in FIG. 1, computing environment 114 may include one or more other systems. For example, computing environment 114 may include a database system 118 and/or a communications grid 120.

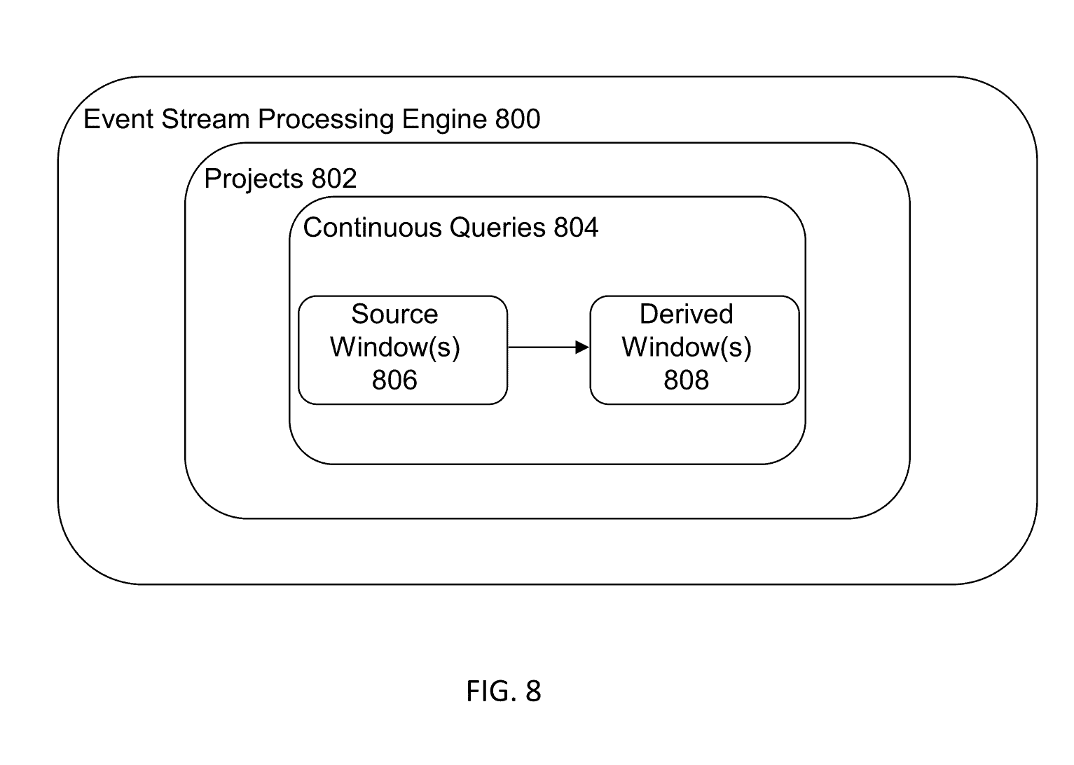

In other embodiments, network devices may provide a large amount of data, either all at once or streaming over a period of time (e.g., using event stream processing (ESP), described further with respect to FIGS. 8-10), to the computing environment 114 via networks 108. For example, network devices 102 may include network computers, sensors, databases, or other devices that may transmit or otherwise provide data to computing environment 114. For example, network devices may include local area network devices, such as routers, hubs, switches, or other computer networking devices. These devices may provide a variety of stored or generated data, such as network data or data specific to the network devices themselves. Network devices may also include sensors that monitor their environment or other devices to collect data regarding that environment or those devices, and such network devices may provide data they collect over time. Network devices may also include devices within the internet of things, such as devices within a home automation network. Some of these devices may be referred to as edge devices, and may involve edge computing circuitry. Data may be transmitted by network devices directly to computing environment 114 or to network-attached data stores, such as network-attached data stores 110 for storage so that the data may be retrieved later by the computing environment 114 or other portions of data transmission network 100.

Data transmission network 100 may also include one or more network-attached data stores 110. Network-attached data stores 110 are used to store data to be processed by the computing environment 114 as well as any intermediate or final data generated by the computing system in non-volatile memory. However in certain embodiments, the configuration of the computing environment 114 allows its operations to be performed such that intermediate and final data results can be stored solely in volatile memory (e.g., RAM), without a requirement that intermediate or final data results be stored to non-volatile types of memory (e.g., disk). This can be useful in certain situations, such as when the computing environment 114 receives ad hoc queries from a user and when responses, which are generated by processing large amounts of data, need to be generated on-the-fly. In this non-limiting situation, the computing environment 114 may be configured to retain the processed information within memory so that responses can be generated for the user at different levels of detail as well as allow a user to interactively query against this information.

Network-attached data stores may store a variety of different types of data organized in a variety of different ways and from a variety of different sources. For example, network-attached data storage may include storage other than primary storage located within computing environment 114 that is directly accessible by processors located therein. Network-attached data storage may include secondary, tertiary or auxiliary storage, such as large hard drives, servers, virtual memory, among other types. Storage devices may include portable or non-portable storage devices, optical storage devices, and various other mediums capable of storing, containing data. A machine-readable storage medium or computer-readable storage medium may include a non-transitory medium in which data can be stored and that does not include carrier waves and/or transitory electronic signals. Examples of a non-transitory medium may include, for example, a magnetic disk or tape, optical storage media such as compact disk or digital versatile disk, flash memory, memory or memory devices. A computer-program product may include code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, among others. Furthermore, the data stores may hold a variety of different types of data. For example, network-attached data stores 110 may hold unstructured (e.g., raw) data, such as manufacturing data (e.g., a database containing records identifying products being manufactured with parameter data for each product, such as colors and models) or product sales databases (e.g., a database containing individual data records identifying details of individual product sales).

The unstructured data may be presented to the computing environment 114 in different forms such as a flat file or a conglomerate of data records, and may have data values and accompanying time stamps. The computing environment 114 may be used to analyze the unstructured data in a variety of ways to determine the best way to structure (e.g., hierarchically) that data, such that the structured data is tailored to a type of further analysis that a user wishes to perform on the data. For example, after being processed, the unstructured time stamped data may be aggregated by time (e.g., into daily time period units) to generate time series data and/or structured hierarchically according to one or more dimensions (e.g., parameters, attributes, and/or variables). For example, data may be stored in a hierarchical data structure, such as a ROLAP OR MOLAP database, or may be stored in another tabular form, such as in a flat-hierarchy form.

Data transmission network 100 may also include one or more server farms 106. Computing environment 114 may route select communications or data to the one or more sever farms 106 or one or more servers within the server farms. Server farms 106 can be configured to provide information in a predetermined manner. For example, server farms 106 may access data to transmit in response to a communication. Server farms 106 may be separately housed from each other device within data transmission network 100, such as computing environment 114, and/or may be part of a device or system.

Server farms 106 may host a variety of different types of data processing as part of data transmission network 100. Server farms 106 may receive a variety of different data from network devices, from computing environment 114, from cloud network 116, or from other sources. The data may have been obtained or collected from one or more sensors, as inputs from a control database, or may have been received as inputs from an external system or device. Server farms 106 may assist in processing the data by turning raw data into processed data based on one or more rules implemented by the server farms. For example, sensor data may be analyzed to determine changes in an environment over time or in real-time.

Data transmission network 100 may also include one or more cloud networks 116. Cloud network 116 may include a cloud infrastructure system that provides cloud services. In certain embodiments, services provided by the cloud network 116 may include a host of services that are made available to users of the cloud infrastructure system on demand. Cloud network 116 is shown in FIG. 1 as being connected to computing environment 114 (and therefore having computing environment 114 as its client or user), but cloud network 116 may be connected to or utilized by any of the devices in FIG. 1. Services provided by the cloud network can dynamically scale to meet the needs of its users. The cloud network 116 may comprise one or more computers, servers, and/or systems. In some embodiments, the computers, servers, and/or systems that make up the cloud network 116 are different from the user's own on-premises computers, servers, and/or systems. For example, the cloud network 116 may host an application, and a user may, via a communication network such as the Internet, on demand, order and use the application.

While each device, server and system in FIG. 1 is shown as a single device, it will be appreciated that multiple devices may instead be used. For example, a set of network devices can be used to transmit various communications from a single user, or remote server 140 may include a server stack. As another example, data may be processed as part of computing environment 114.

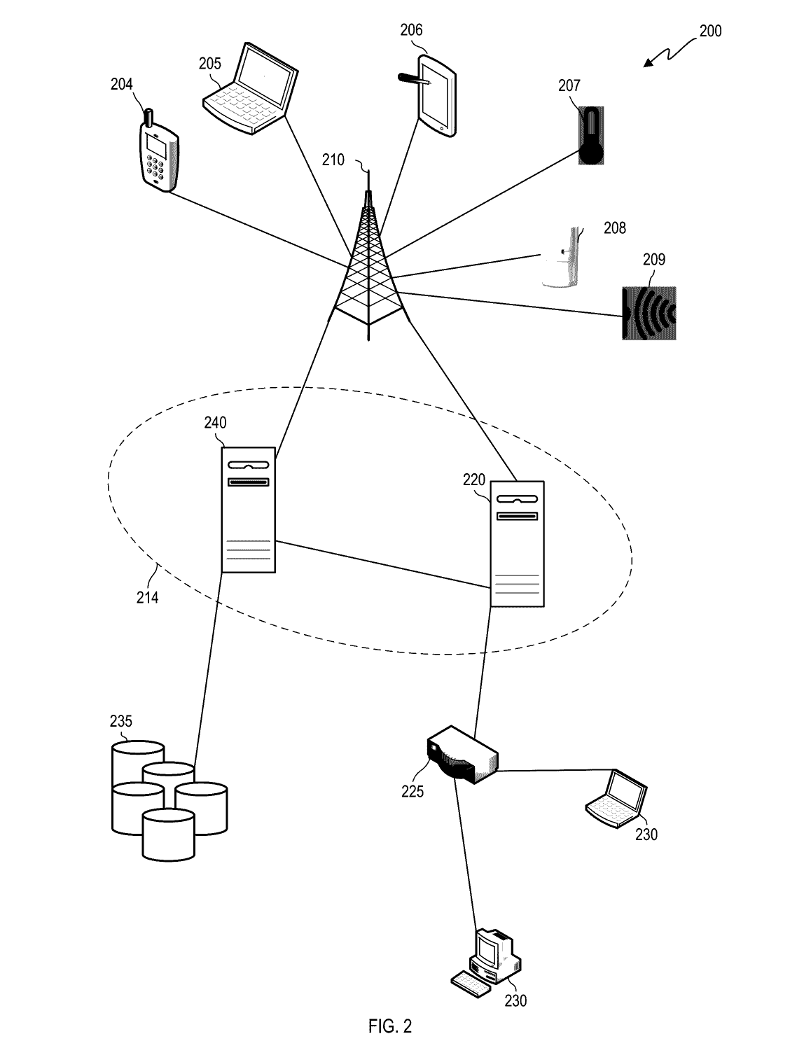

Each communication within data transmission network 100 (e.g., between client devices, between a device and connection management system 150, between servers 106 and computing environment 114 or between a server and a device) may occur over one or more networks 108. Networks 108 may include one or more of a variety of different types of networks, including a wireless network, a wired network, or a combination of a wired and wireless network. Examples of suitable networks include the Internet, a personal area network, a local area network (LAN), a wide area network (WAN), or a wireless local area network (WLAN). A wireless network may include a wireless interface or combination of wireless interfaces. As an example, a network in the one or more networks 108 may include a short-range communication channel, such as a Bluetooth or a Bluetooth Low Energy channel. A wired network may include a wired interface. The wired and/or wireless networks may be implemented using routers, access points, bridges, gateways, or the like, to connect devices in the network 114, as will be further described with respect to FIG. 2. The one or more networks 108 can be incorporated entirely within or can include an intranet, an extranet, or a combination thereof. In one embodiment, communications between two or more systems and/or devices can be achieved by a secure communications protocol, such as secure sockets layer (SSL) or transport layer security (TLS). In addition, data and/or transactional details may be encrypted.

Some aspects may utilize the Internet of Things (IoT), where things (e.g., machines, devices, phones, sensors) can be connected to networks and the data from these things can be collected and processed within the things and/or external to the things. For example, the IoT can include sensors in many different devices, and high value analytics can be applied to identify hidden relationships and drive increased efficiencies. This can apply to both big data analytics and real-time (e.g., ESP) analytics. This will be described further below with respect to FIG. 2.

As noted, computing environment 114 may include a communications grid 120 and a transmission network database system 118. Communications grid 120 may be a grid-based computing system for processing large amounts of data. The transmission network database system 118 may be for managing, storing, and retrieving large amounts of data that are distributed to and stored in the one or more network-attached data stores 110 or other data stores that reside at different locations within the transmission network database system 118. The compute nodes in the grid-based computing system 120 and the transmission network database system 118 may share the same processor hardware, such as processors that are located within computing environment 114.

FIG. 2 illustrates an example network including an example set of devices communicating with each other over an exchange system and via a network, according to embodiments of the present technology. As noted, each communication within data transmission network 100 may occur over one or more networks. System 200 includes a network device 204 configured to communicate with a variety of types of client devices, for example client devices 230, over a variety of types of communication channels.

As shown in FIG. 2, network device 204 can transmit a communication over a network (e.g., a cellular network via a base station 210). The communication can be routed to another network device, such as network devices 205-209, via base station 210. The communication can also be routed to computing environment 214 via base station 210. For example, network device 204 may collect data either from its surrounding environment or from other network devices (such as network devices 205-209) and transmit that data to computing environment 214.

Although network devices 204-209 are shown in FIG. 2 as a mobile phone, laptop computer, tablet computer, temperature sensor, motion sensor, and audio sensor respectively, the network devices may be or include sensors that are sensitive to detecting aspects of their environment. For example, the network devices may include sensors such as water sensors, power sensors, electrical current sensors, chemical sensors, optical sensors, pressure sensors, geographic or position sensors (e.g., GPS), velocity sensors, acceleration sensors, flow rate sensors, among others. Examples of characteristics that may be sensed include force, torque, load, strain, position, temperature, air pressure, fluid flow, chemical properties, resistance, electromagnetic fields, radiation, irradiance, proximity, acoustics, moisture, distance, speed, vibrations, acceleration, electrical potential, electrical current, among others. The sensors may be mounted to various components used as part of a variety of different types of systems (e.g., an oil drilling operation). The network devices may detect and record data related to the environment that it monitors, and transmit that data to computing environment 214.

As noted, one type of system that may include various sensors that collect data to be processed and/or transmitted to a computing environment according to certain embodiments includes an oil drilling system. For example, the one or more drilling operation sensors may include surface sensors that measure a hook load, a fluid rate, a temperature and a density in and out of the wellbore, a standpipe pressure, a surface torque, a rotation speed of a drill pipe, a rate of penetration, a mechanical specific energy, etc. and downhole sensors that measure a rotation speed of a bit, fluid densities, downhole torque, downhole vibration (axial, tangential, lateral), a weight applied at a drill bit, an annular pressure, a differential pressure, an azimuth, an inclination, a dog leg severity, a measured depth, a vertical depth, a downhole temperature, etc. Besides the raw data collected directly by the sensors, other data may include parameters either developed by the sensors or assigned to the system by a client or other controlling device. For example, one or more drilling operation control parameters may control settings such as a mud motor speed to flow ratio, a bit diameter, a predicted formation top, seismic data, weather data, etc. Other data may be generated using physical models such as an earth model, a weather model, a seismic model, a bottom hole assembly model, a well plan model, an annular friction model, etc. In addition to sensor and control settings, predicted outputs, of for example, the rate of penetration, mechanical specific energy, hook load, flow in fluid rate, flow out fluid rate, pump pressure, surface torque, rotation speed of the drill pipe, annular pressure, annular friction pressure, annular temperature, equivalent circulating density, etc. may also be stored in the data warehouse.

In another example, another type of system that may include various sensors that collect data to be processed and/or transmitted to a computing environment according to certain embodiments includes a home automation or similar automated network in a different environment, such as an office space, school, public space, sports venue, or a variety of other locations. Network devices in such an automated network may include network devices that allow a user to access, control, and/or configure various home appliances located within the user's home (e.g., a television, radio, light, fan, humidifier, sensor, microwave, iron, and/or the like), or outside of the user's home (e.g., exterior motion sensors, exterior lighting, garage door openers, sprinkler systems, or the like). For example, network device 102 may include a home automation switch that may be coupled with a home appliance. In another embodiment, a network device can allow a user to access, control, and/or configure devices, such as office-related devices (e.g., copy machine, printer, or fax machine), audio and/or video related devices (e.g., a receiver, a speaker, a projector, a DVD player, or a television), media-playback devices (e.g., a compact disc player, a CD player, or the like), computing devices (e.g., a home computer, a laptop computer, a tablet, a personal digital assistant (PDA), a computing device, or a wearable device), lighting devices (e.g., a lamp or recessed lighting), devices associated with a security system, devices associated with an alarm system, devices that can be operated in an automobile (e.g., radio devices, navigation devices), and/or the like. Data may be collected from such various sensors in raw form, or data may be processed by the sensors to create parameters or other data either developed by the sensors based on the raw data or assigned to the system by a client or other controlling device.

In another example, another type of system that may include various sensors that collect data to be processed and/or transmitted to a computing environment according to certain embodiments includes a power or energy grid. A variety of different network devices may be included in an energy grid, such as various devices within one or more power plants, energy farms (e.g., wind farm, solar farm, among others) energy storage facilities, factories, homes and businesses of consumers, among others. One or more of such devices may include one or more sensors that detect energy gain or loss, electrical input or output or loss, and a variety of other efficiencies. These sensors may collect data to inform users of how the energy grid, and individual devices within the grid, may be functioning and how they may be made more efficient.

Network device sensors may also perform processing on data it collects before transmitting the data to the computing environment 114, or before deciding whether to transmit data to the computing environment 114. For example, network devices may determine whether data collected meets certain rules, for example by comparing data or values calculated from the data and comparing that data to one or more thresholds. The network device may use this data and/or comparisons to determine if the data should be transmitted to the computing environment 214 for further use or processing.

Computing environment 214 may include machines 220 and 240. Although computing environment 214 is shown in FIG. 2 as having two machines, 220 and 240, computing environment 214 may have only one machine or may have more than two machines. The machines that make up computing environment 214 may include specialized computers, servers, or other machines that are configured to individually and/or collectively process large amounts of data. The computing environment 214 may also include storage devices that include one or more databases of structured data, such as data organized in one or more hierarchies, or unstructured data. The databases may communicate with the processing devices within computing environment 214 to distribute data to them. Since network devices may transmit data to computing environment 214, that data may be received by the computing environment 214 and subsequently stored within those storage devices. Data used by computing environment 214 may also be stored in data stores 235, which may also be a part of or connected to computing environment 214.

Computing environment 214 can communicate with various devices via one or more routers 225 or other inter-network or intra-network connection components. For example, computing environment 214 may communicate with devices 230 via one or more routers 225. Computing environment 214 may collect, analyze and/or store data from or pertaining to communications, client device operations, client rules, and/or user-associated actions stored at one or more data stores 235. Such data may influence communication routing to the devices within computing environment 214, how data is stored or processed within computing environment 214, among other actions.

Notably, various other devices can further be used to influence communication routing and/or processing between devices within computing environment 214 and with devices outside of computing environment 214. For example, as shown in FIG. 240, computing environment 214 may include a web server 240. Thus, computing environment 214 can retrieve data of interest, such as client information (e.g., product information, client rules, etc.), technical product details, news, current or predicted weather, and so on.

In addition to computing environment 214 collecting data (e.g., as received from network devices, such as sensors, and client devices or other sources) to be processed as part of a big data analytics project, it may also receive data in real time as part of a streaming analytics environment. As noted, data may be collected using a variety of sources as communicated via different kinds of networks or locally. Such data may be received on a real-time streaming basis. For example, network devices may receive data periodically from network device sensors as the sensors continuously sense, monitor and track changes in their environments. Devices within computing environment 214 may also perform pre-analysis on data it receives to determine if the data received should be processed as part of an ongoing project. The data received and collected by computing environment 214, no matter what the source or method or timing of receipt, may be processed over a period of time for a client to determine results data based on the client's needs and rules.

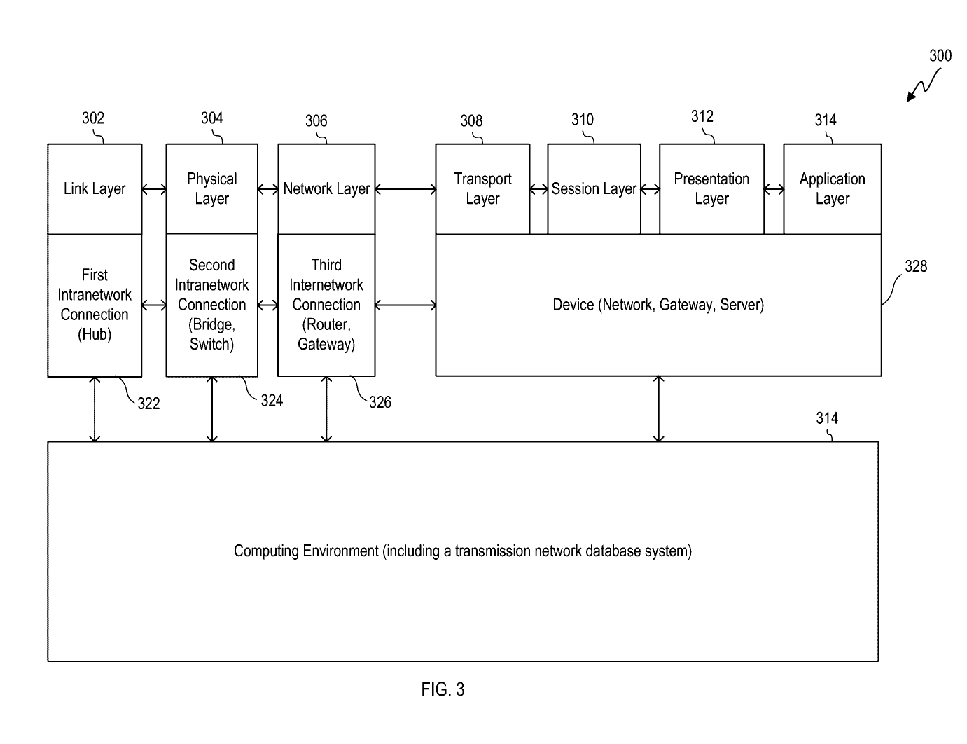

FIG. 3 illustrates a representation of a conceptual model of a communications protocol system, according to embodiments of the present technology. More specifically, FIG. 3 identifies operation of a computing environment in an Open Systems Interaction model that corresponds to various connection components. The model 300 shows, for example, how a computing environment, such as computing environment 314 (or computing environment 214 in FIG. 2) may communicate with other devices in its network, and control how communications between the computing environment and other devices are executed and under what conditions.

The model can include layers 302-314. The layers are arranged in a stack. Each layer in the stack serves the layer one level higher than it (except for the application layer, which is the highest layer), and is served by the layer one level below it (except for the physical layer, which is the lowest layer). The physical layer is the lowest layer because it receives and transmits raw bites of data, and is the farthest layer from the user in a communications system. On the other hand, the application layer is the highest layer because it interacts directly with a software application.

As noted, the model includes a physical layer 302. Physical layer 302 represents physical communication, and can define parameters of that physical communication. For example, such physical communication may come in the form of electrical, optical, or electromagnetic signals. Physical layer 302 also defines protocols that may control communications within a data transmission network.

Link layer 304 defines links and mechanisms used to transmit (i.e., move) data across a network. The link layer manages node-to-node communications, such as within a grid computing environment. Link layer 304 can detect and correct errors (e.g., transmission errors in the physical layer 302). Link layer 304 can also include a media access control (MAC) layer and logical link control (LLC) layer.

Network layer 306 defines the protocol for routing within a network. In other words, the network layer coordinates transferring data across nodes in a same network (e.g., such as a grid computing environment). Network layer 306 can also define the processes used to structure local addressing within the network.

Transport layer 308 can manage the transmission of data and the quality of the transmission and/or receipt of that data. Transport layer 308 can provide a protocol for transferring data, such as, for example, a Transmission Control Protocol (TCP). Transport layer 308 can assemble and disassemble data frames for transmission. The transport layer can also detect transmission errors occurring in the layers below it.

Session layer 310 can establish, maintain, and manage communication connections between devices on a network. In other words, the session layer controls the dialogues or nature of communications between network devices on the network. The session layer may also establish checkpointing, adjournment, termination, and restart procedures.

Presentation layer 312 can provide translation for communications between the application and network layers. In other words, this layer may encrypt, decrypt and/or format data based on data types known to be accepted by an application or network layer.

Application layer 314 interacts directly with software applications and end users, and manages communications between them. Application layer 314 can identify destinations, local resource states or availability and/or communication content or formatting using the applications.

Intra-network connection components 322 and 324 are shown to operate in lower levels, such as physical layer 302 and link layer 304, respectively. For example, a hub can operate in the physical layer, a switch can operate in the physical layer, and a router can operate in the network layer. Inter-network connection components 326 and 328 are shown to operate on higher levels, such as layers 306-314. For example, routers can operate in the network layer and network devices can operate in the transport, session, presentation, and application layers.

As noted, a computing environment 314 can interact with and/or operate on, in various embodiments, one, more, all or any of the various layers. For example, computing environment 314 can interact with a hub (e.g., via the link layer) so as to adjust which devices the hub communicates with. The physical layer may be served by the link layer, so it may implement such data from the link layer. For example, the computing environment 314 may control which devices it will receive data from. For example, if the computing environment 314 knows that a certain network device has turned off, broken, or otherwise become unavailable or unreliable, the computing environment 314 may instruct the hub to prevent any data from being transmitted to the computing environment 314 from that network device. Such a process may be beneficial to avoid receiving data that is inaccurate or that has been influenced by an uncontrolled environment. As another example, computing environment 314 can communicate with a bridge, switch, router or gateway and influence which device within the system (e.g., system 200) the component selects as a destination. In some embodiments, computing environment 314 can interact with various layers by exchanging communications with equipment operating on a particular layer by routing or modifying existing communications. In another embodiment, such as in a grid computing environment, a node may determine how data within the environment should be routed (e.g., which node should receive certain data) based on certain parameters or information provided by other layers within the model.

As noted, the computing environment 314 may be a part of a communications grid environment, the communications of which may be implemented as shown in the protocol of FIG. 3. For example, referring back to FIG. 2, one or more of machines 220 and 240 may be part of a communications grid computing environment. A gridded computing environment may be employed in a distributed system with non-interactive workloads where data resides in memory on the machines, or compute nodes. In such an environment, analytic code, instead of a database management system, controls the processing performed by the nodes. Data is co-located by pre-distributing it to the grid nodes, and the analytic code on each node loads the local data into memory. Each node may be assigned a particular task such as a portion of a processing project, or to organize or control other nodes within the grid.

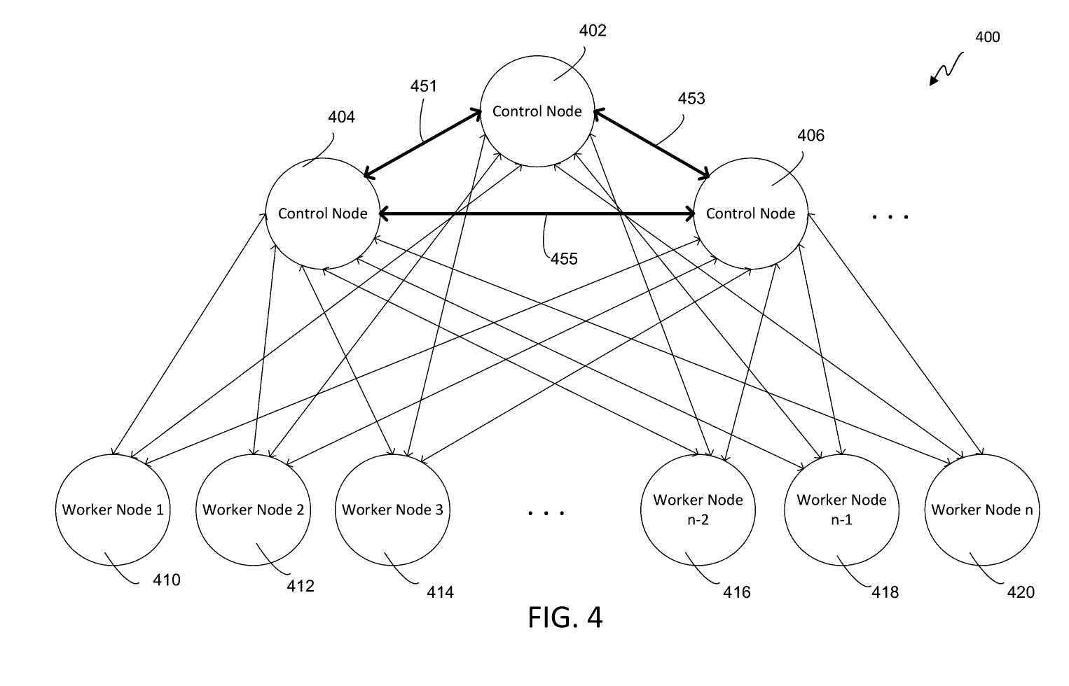

FIG. 4 illustrates a communications grid computing system 400 including a variety of control and worker nodes, according to embodiments of the present technology. Communications grid computing system 400 includes three control nodes and one or more worker nodes. Communications grid computing system 400 includes control nodes 402, 404, and 406. The control nodes are communicatively connected via communication paths 451, 453, and 455. Therefore, the control nodes may transmit information (e.g., related to the communications grid or notifications), to and receive information from each other. Although communications grid computing system 400 is shown in FIG. 4 as including three control nodes, the communications grid may include more or less than three control nodes.

Communications grid computing system (or just “communications grid”) 400 also includes one or more worker nodes. Shown in FIG. 4 are six worker nodes 410-420. Although FIG. 4 shows six worker nodes, a communications grid according to embodiments of the present technology may include more or less than six worker nodes. The number of worker nodes included in a communications grid may be dependent upon how large the project or data set is being processed by the communications grid, the capacity of each worker node, the time designated for the communications grid to complete the project, among others. Each worker node within the communications grid 400 may be connected (wired or wirelessly, and directly or indirectly) to control nodes 402-406. Therefore, each worker node may receive information from the control nodes (e.g., an instruction to perform work on a project) and may transmit information to the control nodes (e.g., a result from work performed on a project). Furthermore, worker nodes may communicate with each other (either directly or indirectly). For example, worker nodes may transmit data between each other related to a job being performed or an individual task within a job being performed by that worker node. However, in certain embodiments, worker nodes may not, for example, be connected (communicatively or otherwise) to certain other worker nodes. In an embodiment, worker nodes may only be able to communicate with the control node that controls it, and may not be able to communicate with other worker nodes in the communications grid, whether they are other worker nodes controlled by the control node that controls the worker node, or worker nodes that are controlled by other control nodes in the communications grid.

A control node may connect with an external device with which the control node may communicate (e.g., a grid user, such as a server or computer, may connect to a controller of the grid). For example, a server or computer may connect to control nodes and may transmit a project or job to the node. The project may include a data set. The data set may be of any size. Once the control node receives such a project including a large data set, the control node may distribute the data set or projects related to the data set to be performed by worker nodes. Alternatively, for a project including a large data set, the data set may be receive or stored by a machine other than a control node (e.g., a Hadoop data node).

Control nodes may maintain knowledge of the status of the nodes in the grid (i.e., grid status information), accept work requests from clients, subdivide the work across worker nodes, coordinate the worker nodes, among other responsibilities. Worker nodes may accept work requests from a control node and provide the control node with results of the work performed by the worker node. A grid may be started from a single node (e.g., a machine, computer, server, etc.). This first node may be assigned or may start as the primary control node that will control any additional nodes that enter the grid.

When a project is submitted for execution (e.g., by a client or a controller of the grid) it may be assigned to a set of nodes. After the nodes are assigned to a project, a data structure (i.e., a communicator) may be created. The communicator may be used by the project for information to be shared between the project code running on each node. A communication handle may be created on each node. A handle, for example, is a reference to the communicator that is valid within a single process on a single node, and the handle may be used when requesting communications between nodes.

A control node, such as control node 402, may be designated as the primary control node. A server, computer or other external device may connect to the primary control node. Once the control node receives a project, the primary control node may distribute portions of the project to its worker nodes for execution. For example, when a project is initiated on communications grid 400, primary control node 402 controls the work to be performed for the project in order to complete the project as requested or instructed. The primary control node may distribute work to the worker nodes based on various factors, such as which subsets or portions of projects may be completed most efficiently and in the correct amount of time. For example, a worker node may perform analysis on a portion of data that is already local (e.g., stored on) the worker node. The primary control node also coordinates and processes the results of the work performed by each worker node after each worker node executes and completes its job. For example, the primary control node may receive a result from one or more worker nodes, and the control node may organize (e.g., collect and assemble) the results received and compile them to produce a complete result for the project received from the end user.

Any remaining control nodes, such as control nodes 404 and 406, may be assigned as backup control nodes for the project. In an embodiment, backup control nodes may not control any portion of the project. Instead, backup control nodes may serve as a backup for the primary control node and take over as primary control node if the primary control node were to fail. If a communications grid were to include only a single control node, and the control node were to fail (e.g., the control node is shut off or breaks) then the communications grid as a whole may fail and any project or job being run on the communications grid may fail and may not complete. While the project may be run again, such a failure may cause a delay (severe delay in some cases, such as overnight delay) in completion of the project. Therefore, a grid with multiple control nodes, including a backup control node, may be beneficial.

To add another node or machine to the grid, the primary control node may open a pair of listening sockets, for example. A socket may be used to accept work requests from clients, and the second socket may be used to accept connections from other grid nodes). The primary control node may be provided with a list of other nodes (e.g., other machines, computers, servers) that will participate in the grid, and the role that each node will fill in the grid. Upon startup of the primary control node (e.g., the first node on the grid), the primary control node may use a network protocol to start the server process on every other node in the grid. Command line parameters, for example, may inform each node of one or more pieces of information, such as: the role that the node will have in the grid, the host name of the primary control node, the port number on which the primary control node is accepting connections from peer nodes, among others. The information may also be provided in a configuration file, transmitted over a secure shell tunnel, recovered from a configuration server, among others. While the other machines in the grid may not initially know about the configuration of the grid, that information may also be sent to each other node by the primary control node. Updates of the grid information may also be subsequently sent to those nodes.

For any control node other than the primary control node added to the grid, the control node may open three sockets. The first socket may accept work requests from clients, the second socket may accept connections from other grid members, and the third socket may connect (e.g., permanently) to the primary control node. When a control node (e.g., primary control node) receives a connection from another control node, it first checks to see if the peer node is in the list of configured nodes in the grid. If it is not on the list, the control node may clear the connection. If it is on the list, it may then attempt to authenticate the connection. If authentication is successful, the authenticating node may transmit information to its peer, such as the port number on which a node is listening for connections, the host name of the node, information about how to authenticate the node, among other information. When a node, such as the new control node, receives information about another active node, it will check to see if it already has a connection to that other node. If it does not have a connection to that node, it may then establish a connection to that control node.

Any worker node added to the grid may establish a connection to the primary control node and any other control nodes on the grid. After establishing the connection, it may authenticate itself to the grid (e.g., any control nodes, including both primary and backup, or a server or user controlling the grid). After successful authentication, the worker node may accept configuration information from the control node.

When a node joins a communications grid (e.g., when the node is powered on or connected to an existing node on the grid or both), the node is assigned (e.g., by an operating system of the grid) a universally unique identifier (UUID). This unique identifier may help other nodes and external entities (devices, users, etc.) to identify the node and distinguish it from other nodes. When a node is connected to the grid, the node may share its unique identifier with the other nodes in the grid. Since each node may share its unique identifier, each node may know the unique identifier of every other node on the grid. Unique identifiers may also designate a hierarchy of each of the nodes (e.g., backup control nodes) within the grid. For example, the unique identifiers of each of the backup control nodes may be stored in a list of backup control nodes to indicate an order in which the backup control nodes will take over for a failed primary control node to become a new primary control node. However, a hierarchy of nodes may also be determined using methods other than using the unique identifiers of the nodes. For example, the hierarchy may be predetermined, or may be assigned based on other predetermined factors.

The grid may add new machines at any time (e.g., initiated from any control node). Upon adding a new node to the grid, the control node may first add the new node to its table of grid nodes. The control node may also then notify every other control node about the new node. The nodes receiving the notification may acknowledge that they have updated their configuration information.

Primary control node 402 may, for example, transmit one or more communications to backup control nodes 404 and 406 (and, for example, to other control or worker nodes within the communications grid). Such communications may sent periodically, at fixed time intervals, between known fixed stages of the project's execution, among other protocols. The communications transmitted by primary control node 402 may be of varied types and may include a variety of types of information. For example, primary control node 402 may transmit snapshots (e.g., status information) of the communications grid so that backup control node 404 always has a recent snapshot of the communications grid. The snapshot or grid status may include, for example, the structure of the grid (including, for example, the worker nodes in the grid, unique identifiers of the nodes, or their relationships with the primary control node) and the status of a project (including, for example, the status of each worker node's portion of the project). The snapshot may also include analysis or results received from worker nodes in the communications grid. The backup control nodes may receive and store the backup data received from the primary control node. The backup control nodes may transmit a request for such a snapshot (or other information) from the primary control node, or the primary control node may send such information periodically to the backup control nodes.

As noted, the backup data may allow the backup control node to take over as primary control node if the primary control node fails without requiring the grid to start the project over from scratch. If the primary control node fails, the backup control node that will take over as primary control node may retrieve the most recent version of the snapshot received from the primary control node and use the snapshot to continue the project from the stage of the project indicated by the backup data. This may prevent failure of the project as a whole.

A backup control node may use various methods to determine that the primary control node has failed. In one example of such a method, the primary control node may transmit (e.g., periodically) a communication to the backup control node that indicates that the primary control node is working and has not failed, such as a heartbeat communication. The backup control node may determine that the primary control node has failed if the backup control node has not received a heartbeat communication for a certain predetermined period of time. Alternatively, a backup control node may also receive a communication from the primary control node itself (before it failed) or from a worker node that the primary control node has failed, for example because the primary control node has failed to communicate with the worker node.

Different methods may be performed to determine which backup control node of a set of backup control nodes (e.g., backup control nodes 404 and 406) will take over for failed primary control node 402 and become the new primary control node. For example, the new primary control node may be chosen based on a ranking or “hierarchy” of backup control nodes based on their unique identifiers. In an alternative embodiment, a backup control node may be assigned to be the new primary control node by another device in the communications grid or from an external device (e.g., a system infrastructure or an end user, such as a server or computer, controlling the communications grid). In another alternative embodiment, the backup control node that takes over as the new primary control node may be designated based on bandwidth or other statistics about the communications grid.

A worker node within the communications grid may also fail. If a worker node fails, work being performed by the failed worker node may be redistributed amongst the operational worker nodes. In an alternative embodiment, the primary control node may transmit a communication to each of the operable worker nodes still on the communications grid that each of the worker nodes should purposefully fail also. After each of the worker nodes fail, they may each retrieve their most recent saved checkpoint of their status and restart the project from that checkpoint to minimize lost progress on the project being executed.

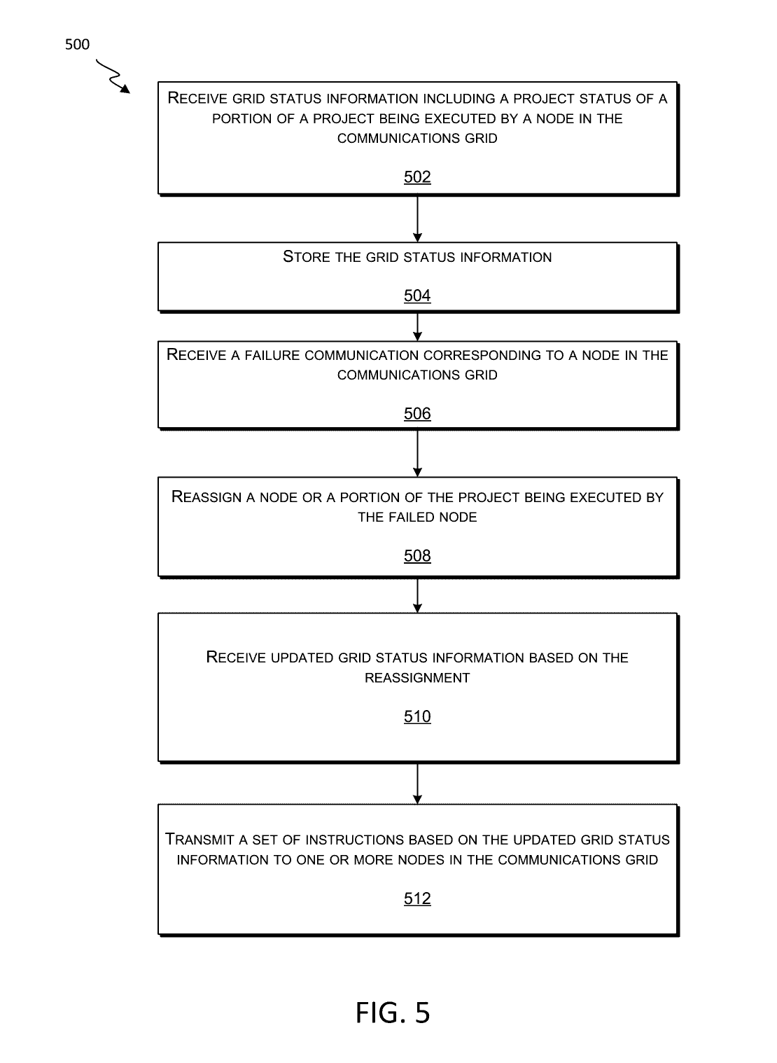

FIG. 5 illustrates a flow chart showing an example process 500 for adjusting a communications grid or a work project in a communications grid after a failure of a node, according to embodiments of the present technology. The process 500 may include, for example, receiving grid status information including a project status of a portion of a project being executed by a node in the communications grid, as described in operation 502. For example, a control node (e.g., a backup control node connected to a primary control node and a worker node on a communications grid) may receive grid status information, where the grid status information includes a project status of the primary control node or a project status of the worker node. The project status of the primary control node and the project status of the worker node may include a status of one or more portions of a project being executed by the primary and worker nodes in the communications grid. The process 500 may also include storing the grid status information, as described in operation 504. For example, a control node (e.g., a backup control node) may store the received grid status information locally within the control node. Alternatively, the grid status information may be sent to another device for storage where the control node may have access to the information.

The process 500 may also include receiving a failure communication corresponding to a node in the communications grid in operation 506. For example, a node may receive a failure communication including an indication that the primary control node has failed, prompting a backup control node to take over for the primary control node. In an alternative embodiment, a node may receive a failure that a worker node has failed, prompting a control node to reassign the work being performed by the worker node. The process 500 may also include reassigning a node or a portion of the project being executed by the failed node, as described in operation 508. For example, a control node may designate the backup control node as a new primary control node based on the failure communication upon receiving the failure communication. If the failed node is a worker node, a control node may identify a project status of the failed worker node using the snapshot of the communications grid, where the project status of the failed worker node includes a status of a portion of the project being executed by the failed worker node at the failure time.

The process 500 may also include receiving updated grid status information based on the reassignment, as described in operation 510, and transmitting a set of instructions based on the updated grid status information to one or more nodes in the communications grid, as described in operation 512. The updated grid status information may include an updated project status of the primary control node or an updated project status of the worker node. The updated information may be transmitted to the other nodes in the grid to update their stale stored information.

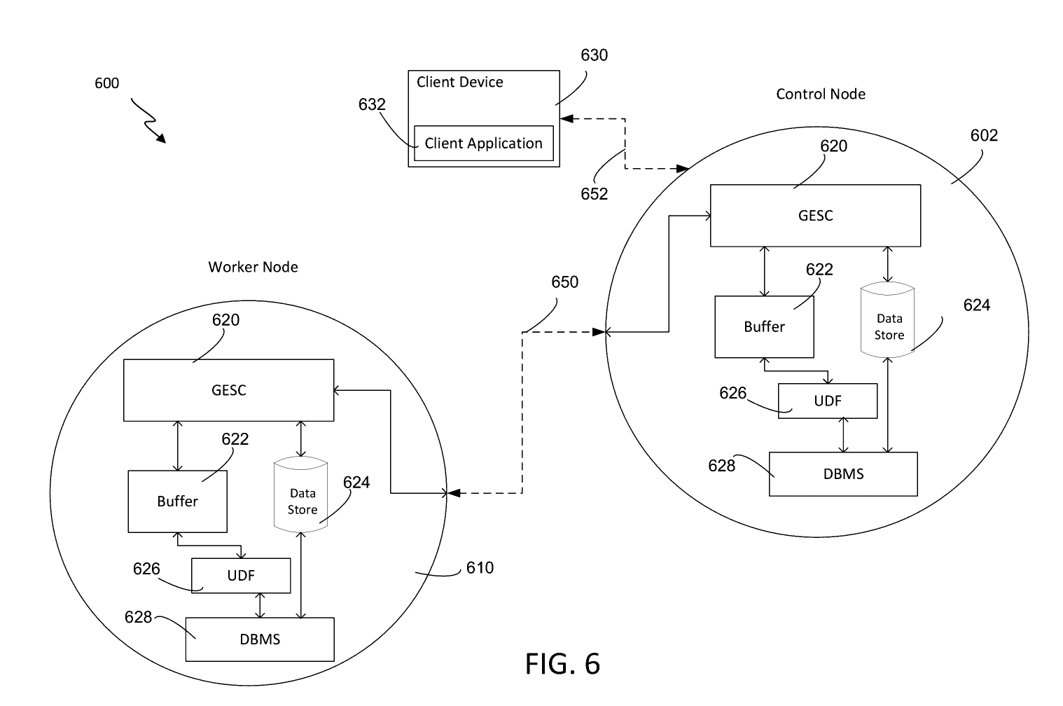

FIG. 6 illustrates a portion of a communications grid computing system 600 including a control node and a worker node, according to embodiments of the present technology. Communications grid 600 computing system includes one control node (control node 602) and one worker node (worker node 610) for purposes of illustration, but may include more worker and/or control nodes. The control node 602 is communicatively connected to worker node 610 via communication path 650. Therefore, control node 602 may transmit information (e.g., related to the communications grid or notifications), to and receive information from worker node 610 via path 650.

Similar to in FIG. 4, communications grid computing system (or just “communications grid”) 600 includes data processing nodes (control node 602 and worker node 610). Nodes 602 and 610 comprise multi-core data processors. Each node 602 and 610 includes a grid-enabled software component (GESC) 620 that executes on the data processor associated with that node and interfaces with buffer memory 622 also associated with that node. Each node 602 and 610 includes a database management software (DBMS) 628 that executes on a database server (not shown) at control node 602 and on a database server (not shown) at worker node 610.

Each node also includes a data store 624. Data stores 624, similar to network-attached data stores 110 in FIG. 1 and data stores 235 in FIG. 2, are used to store data to be processed by the nodes in the computing environment. Data stores 624 may also store any intermediate or final data generated by the computing system after being processed, for example in non-volatile memory. However in certain embodiments, the configuration of the grid computing environment allows its operations to be performed such that intermediate and final data results can be stored solely in volatile memory (e.g., RAM), without a requirement that intermediate or final data results be stored to non-volatile types of memory. Storing such data in volatile memory may be useful in certain situations, such as when the grid receives queries (e.g., ad hoc) from a client and when responses, which are generated by processing large amounts of data, need to be generated quickly or on-the-fly. In such a situation, the grid may be configured to retain the data within memory so that responses can be generated at different levels of detail and so that a client may interactively query against this information.

Each node also includes a user-defined function (UDF) 626. The UDF provides a mechanism for the DMBS 628 to transfer data to or receive data from the database stored in the data stores 624 that are managed by the DBMS. For example, UDF 626 can be invoked by the DBMS to provide data to the GESC for processing. The UDF 626 may establish a socket connection (not shown) with the GESC to transfer the data. Alternatively, the UDF 626 can transfer data to the GESC by writing data to shared memory accessible by both the UDF and the GESC.

The GESC 620 at the nodes 602 and 620 may be connected via a network, such as network 108 shown in FIG. 1. Therefore, nodes 602 and 620 can communicate with each other via the network using a predetermined communication protocol such as, for example, the Message Passing Interface (MPI). Each GESC 620 can engage in point-to-point communication with the GESC at another node or in collective communication with multiple GESCs via the network. The GESC 620 at each node may contain identical (or nearly identical) software instructions. Each node may be capable of operating as either a control node or a worker node. The GESC at the control node 602 can communicate, over a communication path 652, with a client device 630. More specifically, control node 602 may communicate with client application 632 hosted by the client device 630 to receive queries and to respond to those queries after processing large amounts of data.

DMBS 628 may control the creation, maintenance, and use of database or data structure (not shown) within a nodes 602 or 610. The database may organize data stored in data stores 624. The DMBS 628 at control node 602 may accept requests for data and transfer the appropriate data for the request. With such a process, collections of data may be distributed across multiple physical locations. In this example, each node 602 and 610 stores a portion of the total data managed by the management system in its associated data store 624.

Furthermore, the DBMS may be responsible for protecting against data loss using replication techniques. Replication includes providing a backup copy of data stored on one node on one or more other nodes. Therefore, if one node fails, the data from the failed node can be recovered from a replicated copy residing at another node. However, as described herein with respect to FIG. 4, data or status information for each node in the communications grid may also be shared with each node on the grid.

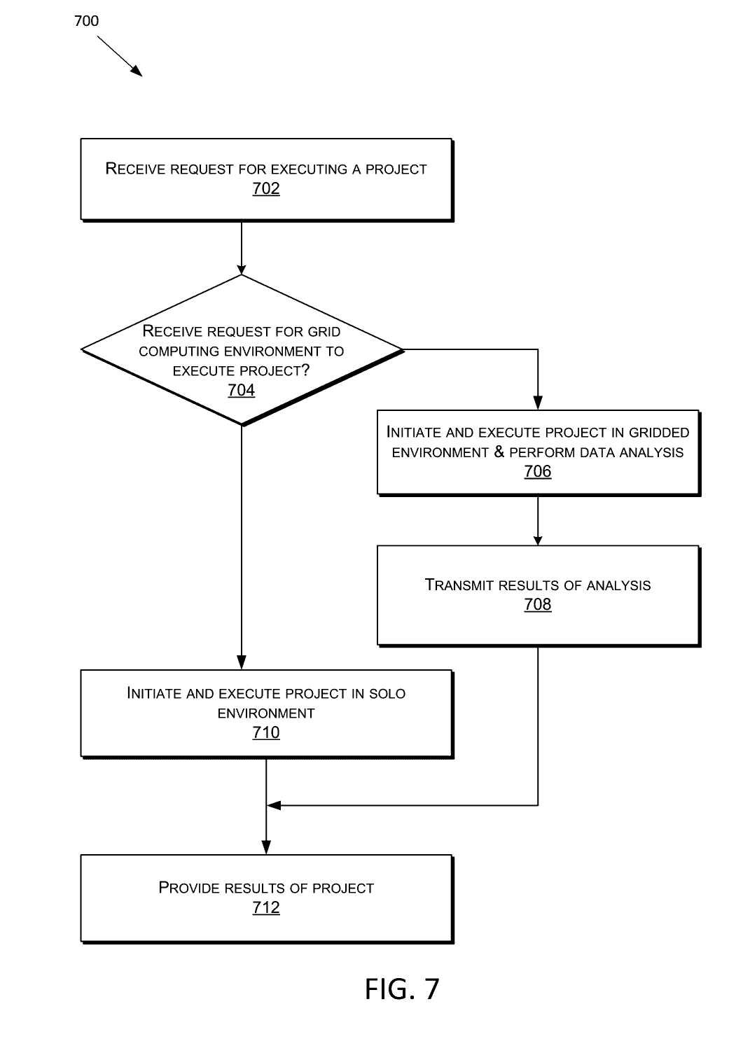

FIG. 7 illustrates a flow chart showing an example method 700 for executing a project within a grid computing system, according to embodiments of the present technology. As described with respect to FIG. 6, the GESC at the control node may transmit data with a client device (e.g., client device 630) to receive queries for executing a project and to respond to those queries after large amounts of data have been processed. The query may be transmitted to the control node, where the query may include a request for executing a project, as described in operation 702. The query can contain instructions on the type of data analysis to be performed in the project and whether the project should be executed using the grid-based computing environment, as shown in operation 704.

To initiate the project, the control node may determine if the query requests use of the grid-based computing environment to execute the project. If the determination is no, then the control node initiates execution of the project in a solo environment (e.g., at the control node), as described in operation 710. If the determination is yes, the control node may initiate execution of the project in the grid-based computing environment, as described in operation 706. In such a situation, the request may include a requested configuration of the grid. For example, the request may include a number of control nodes and a number of worker nodes to be used in the grid when executing the project. After the project has been completed, the control node may transmit results of the analysis yielded by the grid, as described in operation 708. Whether the project is executed in a solo or grid-based environment, the control node provides the results of the project.

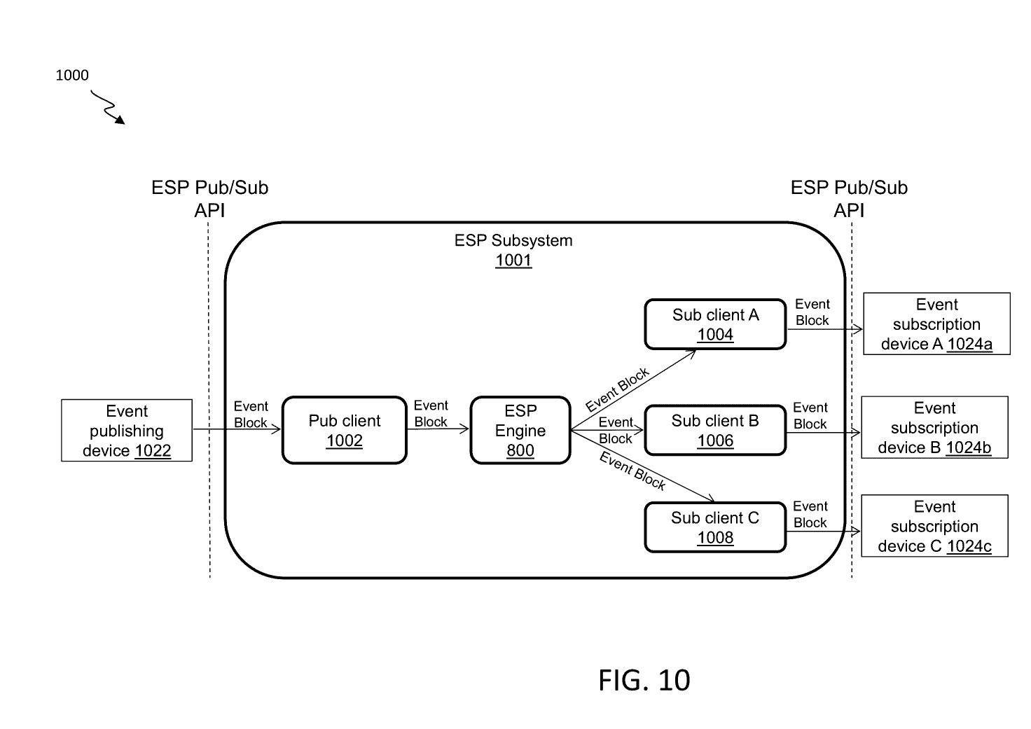

As noted with respect to FIG. 2, the computing environments described herein may collect data (e.g., as received from network devices, such as sensors, such as network devices 204-209 in FIG. 2, and client devices or other sources) to be processed as part of a data analytics project, and data may be received in real time as part of a streaming analytics environment (e.g., ESP). Data may be collected using a variety of sources as communicated via different kinds of networks or locally, such as on a real-time streaming basis. For example, network devices may receive data periodically from network device sensors as the sensors continuously sense, monitor and track changes in their environments. More specifically, an increasing number of distributed applications develop or produce continuously flowing data from distributed sources by applying queries to the data before distributing the data to geographically distributed recipients. An event stream processing engine (ESPE) may continuously apply the queries to the data as it is received and determines which entities should receive the data. Client or other devices may also subscribe to the ESPE or other devices processing ESP data so that they can receive data after processing, based on for example the entities determined by the processing engine. For example, client devices 230 in FIG. 2 may subscribe to the ESPE in computing environment 214. In another example, event subscription devices 1024a-c, described further with respect to FIG. 10, may also subscribe to the ESPE. The ESPE may determine or define how input data or event streams from network devices or other publishers (e.g., network devices 204-209 in FIG. 2) are transformed into meaningful output data to be consumed by subscribers, such as for example client devices 230 in FIG. 2.

FIG. 8 illustrates a block diagram including components of an Event Stream Processing Engine (ESPE), according to embodiments of the present technology. ESPE 800 may include one or more projects 802. A project may be described as a second-level container in an engine model managed by ESPE 800 where a thread pool size for the project may be defined by a user. Each project of the one or more projects 802 may include one or more continuous queries 804 that contain data flows, which are data transformations of incoming event streams. The one or more continuous queries 804 may include one or more source windows 806 and one or more derived windows 808.

The ESPE may receive streaming data over a period of time related to certain events, such as events or other data sensed by one or more network devices. The ESPE may perform operations associated with processing data created by the one or more devices. For example, the ESPE may receive data from the one or more network devices 204-209 shown in FIG. 2. As noted, the network devices may include sensors that sense different aspects of their environments, and may collect data over time based on those sensed observations. For example, the ESPE may be implemented within one or more of machines 220 and 240 shown in FIG. 2. The ESPE may be implemented within such a machine by an ESP application. An ESP application may embed an ESPE with its own dedicated thread pool or pools into its application space where the main application thread can do application-specific work and the ESPE processes event streams at least by creating an instance of a model into processing objects.

The engine container is the top-level container in a model that manages the resources of the one or more projects 802. In an illustrative embodiment, for example, there may be only one ESPE 800 for each instance of the ESP application, and ESPE 800 may have a unique engine name. Additionally, the one or more projects 802 may each have unique project names, and each query may have a unique continuous query name and begin with a uniquely named source window of the one or more source windows 806. ESPE 800 may or may not be persistent.

Continuous query modeling involves defining directed graphs of windows for event stream manipulation and transformation. A window in the context of event stream manipulation and transformation is a processing node in an event stream processing model. A window in a continuous query can perform aggregations, computations, pattern-matching, and other operations on data flowing through the window. A continuous query may be described as a directed graph of source, relational, pattern matching, and procedural windows. The one or more source windows 806 and the one or more derived windows 808 represent continuously executing queries that generate updates to a query result set as new event blocks stream through ESPE 800. A directed graph, for example, is a set of nodes connected by edges, where the edges have a direction associated with them.

An event object may be described as a packet of data accessible as a collection of fields, with at least one of the fields defined as a key or unique identifier (ID). The event object may be created using a variety of formats including binary, alphanumeric, XML, etc. Each event object may include one or more fields designated as a primary identifier (ID) for the event so ESPE 800 can support operation codes (opcodes) for events including insert, update, upsert, and delete. Upsert opcodes update the event if the key field already exists; otherwise, the event is inserted. For illustration, an event object may be a packed binary representation of a set of field values and include both metadata and field data associated with an event. The metadata may include an opcode indicating if the event represents an insert, update, delete, or upsert, a set of flags indicating if the event is a normal, partial-update, or a retention generated event from retention policy management, and a set of microsecond timestamps that can be used for latency measurements.

An event block object may be described as a grouping or package of event objects. An event stream may be described as a flow of event block objects. A continuous query of the one or more continuous queries 804 transforms a source event stream made up of streaming event block objects published into ESPE 800 into one or more output event streams using the one or more source windows 806 and the one or more derived windows 808. A continuous query can also be thought of as data flow modeling.

The one or more source windows 806 are at the top of the directed graph and have no windows feeding into them. Event streams are published into the one or more source windows 806, and from there, the event streams may be directed to the next set of connected windows as defined by the directed graph. The one or more derived windows 808 are all instantiated windows that are not source windows and that have other windows streaming events into them. The one or more derived windows 808 may perform computations or transformations on the incoming event streams. The one or more derived windows 808 transform event streams based on the window type (that is operators such as join, filter, compute, aggregate, copy, pattern match, procedural, union, etc.) and window settings. As event streams are published into ESPE 800, they are continuously queried, and the resulting sets of derived windows in these queries are continuously updated.

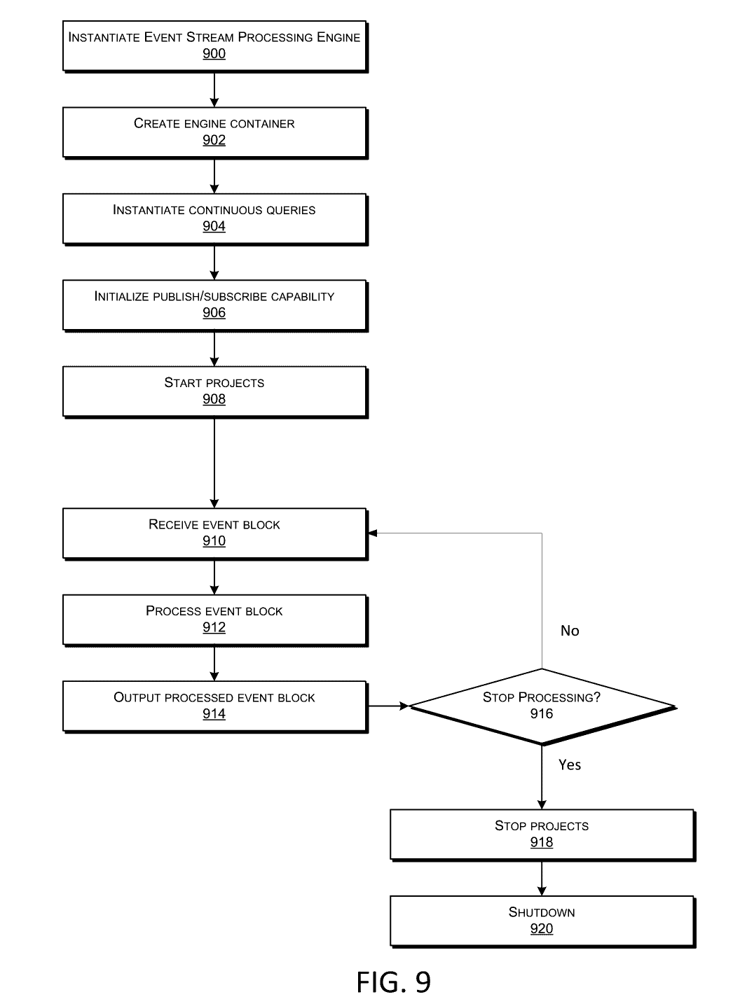

FIG. 9 illustrates a flow chart showing an example process including operations performed by an event stream processing engine, according to some embodiments of the present technology. As noted, the ESPE 800 (or an associated ESP application) defines how input event streams are transformed into meaningful output event streams. More specifically, the ESP application may define how input event streams from publishers (e.g., network devices providing sensed data) are transformed into meaningful output event streams consumed by subscribers (e.g., a data analytics project being executed by a machine or set of machines).

Within the application, a user may interact with one or more user interface windows presented to the user in a display under control of the ESPE independently or through a browser application in an order selectable by the user. For example, a user may execute an ESP application, which causes presentation of a first user interface window, which may include a plurality of menus and selectors such as drop down menus, buttons, text boxes, hyperlinks, etc. associated with the ESP application as understood by a person of skill in the art. As further understood by a person of skill in the art, various operations may be performed in parallel, for example, using a plurality of threads.

At operation 900, an ESP application may define and start an ESPE, thereby instantiating an ESPE at a device, such as machine 220 and/or 240. In an operation 902, the engine container is created. For illustration, ESPE 800 may be instantiated using a function call that specifies the engine container as a manager for the model.

In an operation 904, the one or more continuous queries 804 are instantiated by ESPE 800 as a model. The one or more continuous queries 804 may be instantiated with a dedicated thread pool or pools that generate updates as new events stream through ESPE 800. For illustration, the one or more continuous queries 804 may be created to model business processing logic within ESPE 800, to predict events within ESPE 800, to model a physical system within ESPE 800, to predict the physical system state within ESPE 800, etc. For example, as noted, ESPE 800 may be used to support sensor data monitoring and management (e.g., sensing may include force, torque, load, strain, position, temperature, air pressure, fluid flow, chemical properties, resistance, electromagnetic fields, radiation, irradiance, proximity, acoustics, moisture, distance, speed, vibrations, acceleration, electrical potential, or electrical current, etc.).

ESPE 800 may analyze and process events in motion or “event streams.” Instead of storing data and running queries against the stored data, ESPE 800 may store queries and stream data through them to allow continuous analysis of data as it is received. The one or more source windows 806 and the one or more derived windows 808 may be created based on the relational, pattern matching, and procedural algorithms that transform the input event streams into the output event streams to model, simulate, score, test, predict, etc. based on the continuous query model defined and application to the streamed data.

In an operation 906, a publish/subscribe (pub/sub) capability is initialized for ESPE 800. In an illustrative embodiment, a pub/sub capability is initialized for each project of the one or more projects 802. To initialize and enable pub/sub capability for ESPE 800, a port number may be provided. Pub/sub clients can use a host name of an ESP device running the ESPE and the port number to establish pub/sub connections to ESPE 800.

FIG. 10 illustrates an ESP system 1000 interfacing between publishing device 1022 and event subscribing devices 1024a-c, according to embodiments of the present technology. ESP system 1000 may include ESP device or subsystem 1001, event publishing device 1022, an event subscribing device A 1024a, an event subscribing device B 1024b, and an event subscribing device C 1024c. Input event streams are output to ESP device 1001 by publishing device 1022. In alternative embodiments, the input event streams may be created by a plurality of publishing devices. The plurality of publishing devices further may publish event streams to other ESP devices. The one or more continuous queries instantiated by ESPE 800 may analyze and process the input event streams to form output event streams output to event subscribing device A 1024a, event subscribing device B 1024b, and event subscribing device C 1024c. ESP system 1000 may include a greater or a fewer number of event subscribing devices of event subscribing devices.

Publish-subscribe is a message-oriented interaction paradigm based on indirect addressing. Processed data recipients specify their interest in receiving information from ESPE 800 by subscribing to specific classes of events, while information sources publish events to ESPE 800 without directly addressing the receiving parties. ESPE 800 coordinates the interactions and processes the data. In some cases, the data source receives confirmation that the published information has been received by a data recipient.

A publish/subscribe API may be described as a library that enables an event publisher, such as publishing device 1022, to publish event streams into ESPE 800 or an event subscriber, such as event subscribing device A 1024a, event subscribing device B 1024b, and event subscribing device C 1024c, to subscribe to event streams from ESPE 800. For illustration, one or more publish/subscribe APIs may be defined. Using the publish/subscribe API, an event publishing application may publish event streams into a running event stream processor project source window of ESPE 800, and the event subscription application may subscribe to an event stream processor project source window of ESPE 800.

The publish/subscribe API provides cross-platform connectivity and endianness compatibility between ESP application and other networked applications, such as event publishing applications instantiated at publishing device 1022, and event subscription applications instantiated at one or more of event subscribing device A 1024a, event subscribing device B 1024b, and event subscribing device C 1024c.

Referring back to FIG. 9, operation 906 initializes the publish/subscribe capability of ESPE 800. In an operation 908, the one or more projects 802 are started. The one or more started projects may run in the background on an ESP device. In an operation 910, an event block object is received from one or more computing device of the event publishing device 1022.

ESP subsystem 800 may include a publishing client 1002, ESPE 800, a subscribing client A 1004, a subscribing client B 1006, and a subscribing client C 1008. Publishing client 1002 may be started by an event publishing application executing at publishing device 1022 using the publish/subscribe API. Subscribing client A 1004 may be started by an event subscription application A, executing at event subscribing device A 1024a using the publish/subscribe API. Subscribing client B 1006 may be started by an event subscription application B executing at event subscribing device B 1024b using the publish/subscribe API. Subscribing client C 1008 may be started by an event subscription application C executing at event subscribing device C 1024c using the publish/subscribe API.

An event block object containing one or more event objects is injected into a source window of the one or more source windows 806 from an instance of an event publishing application on event publishing device 1022. The event block object may generated, for example, by the event publishing application and may be received by publishing client 1002. A unique ID may be maintained as the event block object is passed between the one or more source windows 806 and/or the one or more derived windows 808 of ESPE 800, and to subscribing client A 1004, subscribing client B 806, and subscribing client C 808 and to event subscription device A 1024a, event subscription device B 1024b, and event subscription device C 1024c. Publishing client 1002 may further generate and include a unique embedded transaction ID in the event block object as the event block object is processed by a continuous query, as well as the unique ID that publishing device 1022 assigned to the event block object.

In an operation 912, the event block object is processed through the one or more continuous queries 804. In an operation 914, the processed event block object is output to one or more computing devices of the event subscribing devices 1024a-c. For example, subscribing client A 804, subscribing client B 806, and subscribing client C 808 may send the received event block object to event subscription device A 1024a, event subscription device B 1024b, and event subscription device C 1024c, respectively.

ESPE 800 maintains the event block containership aspect of the received event blocks from when the event block is published into a source window and works its way through the directed graph defined by the one or more continuous queries 804 with the various event translations before being output to subscribers. Subscribers can correlate a group of subscribed events back to a group of published events by comparing the unique ID of the event block object that a publisher, such as publishing device 1022, attached to the event block object with the event block ID received by the subscriber.

In an operation 916, a determination is made concerning whether or not processing is stopped. If processing is not stopped, processing continues in operation 910 to continue receiving the one or more event streams containing event block objects from the, for example, one or more network devices. If processing is stopped, processing continues in an operation 918. In operation 918, the started projects are stopped. In operation 920, the ESPE is shutdown.

As noted, in some embodiments, big data is processed for an analytics project after the data is received and stored. In other embodiments, distributed applications process continuously flowing data in real-time from distributed sources by applying queries to the data before distributing the data to geographically distributed recipients. As noted, an event stream processing engine (ESPE) may continuously apply the queries to the data as it is received and determines which entities receive the processed data. This allows for large amounts of data being received and/or collected in a variety of environments to be processed and distributed in real time. For example, as shown with respect to FIG. 2, data may be collected from network devices that may include devices within the internet of things, such as devices within a home automation network. However, such data may be collected from a variety of different resources in a variety of different environments. In any such situation, embodiments of the present technology allow for real-time processing of such data.

Aspects of the current disclosure provide technical solutions to technical problems, such as computing problems that arise when an ESP device fails which results in a complete service interruption and potentially significant data loss. The data loss can be catastrophic when the streamed data is supporting mission critical operations such as those in support of an ongoing manufacturing or drilling operation. An embodiment of an ESP system achieves a rapid and seamless failover of ESPE running at the plurality of ESP devices without service interruption or data loss, thus significantly improving the reliability of an operational system that relies on the live or real-time processing of the data streams. The event publishing systems, the event subscribing systems, and each ESPE not executing at a failed ESP device are not aware of or effected by the failed ESP device. The ESP system may include thousands of event publishing systems and event subscribing systems. The ESP system keeps the failover logic and awareness within the boundaries of out-messaging network connector and out-messaging network device.

In one example embodiment, a system is provided to support a failover when event stream processing (ESP) event blocks. The system includes, but is not limited to, an out-messaging network device and a computing device. The computing device includes, but is not limited to, a processor and a computer-readable medium operably coupled to the processor. The processor is configured to execute an ESP engine (ESPE). The computer-readable medium has instructions stored thereon that, when executed by the processor, cause the computing device to support the failover. An event block object is received from the ESPE that includes a unique identifier. A first status of the computing device as active or standby is determined. When the first status is active, a second status of the computing device as newly active or not newly active is determined. Newly active is determined when the computing device is switched from a standby status to an active status. When the second status is newly active, a last published event block object identifier that uniquely identifies a last published event block object is determined. A next event block object is selected from a non-transitory computer-readable medium accessible by the computing device. The next event block object has an event block object identifier that is greater than the determined last published event block object identifier. The selected next event block object is published to an out-messaging network device. When the second status of the computing device is not newly active, the received event block object is published to the out-messaging network device. When the first status of the computing device is standby, the received event block object is stored in the non-transitory computer-readable medium.

The aspects described herein with reference to FIGS. 1-10 can be used with the aspects disclosed in U.S. patent application Ser. No. 12/683,020 filed Jan. 6, 2010, entitled “Hybrid Simulation Methodologies to Simulate Risk Factors,” such as described in further detail herein, which application is hereby incorporated by reference.

FIG. 11 depicts a computer-implemented environment 1100 wherein users 1102 can interact with a hybrid simulation engine 1104 hosted on one or more servers 1106 through a network 1108. The hybrid simulation engine 1104 enables specification of the most appropriate simulation methods to be applied to subgroups of risk factors within the overall risk system. For example, users can determine which subset of risk factors for which the user may want to emphasize an accurate forecast, while for other risk factors the user may wish focus on fast simulation computation based on the nature of the risk factors or the availability of historical data (e.g., past data). This flexibility enables a user to determine the optimal tradeoff between accuracy and performance when simulating a complicated system. The hybrid simulation engine 1104 may retain original correlation structures in order to maintain correlations among risk factors simulated using different simulation methods during operation of those different simulation methods. For example, algorithms specified by the marginal distribution and copula theorems may be used to maintain the correlation structure of risk factors simulated by the different simulation methods.

A hybrid simulation generator 1104 may be utilized in a variety of ways. For example, users want to model multiple groups of risk factors that describe different sources of risk in one integrated system. Different risk factor groups may be best modeled by specific simulation methods. The hybrid simulation engine 1104 provides one, easy mechanism to capture all the risk sources at the same time. As another example, it may be desirable to put time and effort into modeling risk factors that have a significant impact on a target forecast variable and to use simpler methods to model the remaining factors. This hybrid simulation engine provides flexibility for using more computational time on the risk factors that are deemed important and less time on the remaining risk factors. As a further example, it may be desirable to retain the correlation structure of a risk system which either is specified by the user 1102 or extracted a time-series dataset. The hybrid simulation engine 1104 provides the capability for using different simulation methods to subgroups of risk factor while retaining the original correlation structure among variables in those different simulations during the simulations.

A hybrid simulation engine 1104 may increase capability and flexibility of simulations, simulate systems with various characteristics of risk factors, generated an integrated simulation result, improve performance without significant loss of accuracy, provide easy specification of large systems of risk factors, retain the original correlation relationships of all risk factors, as well as many other features as described herein. The system 1104 contains software operations or routines for providing a simulated forecast based on correlated members of a pool of input risk factor variables representing input data, such as historical time-series data. The generated data model can be used for many different purposes, such as simulation of physical processes (e.g., manufacturing processes, financial transaction processes, etc.) over a period of time. The users 1102 can interact with the system 1104 through a number of ways, such as over one or more networks 1108. One or more servers 1106 accessible through the network(s) 1108 can host the hybrid simulation engine 1104. The hybrid simulation engine 1104 provides a simulated forecast based on correlated members of a pool of input risk factor variables representing input data. The one or more servers 1106 are responsive to one or more data stores 1110 for providing input data to the hybrid simulation engine 1104. Among the data contained on the one or more data stores 1110 may be risk factor historical data 1112 used in configuring data models for simulations as well as simulation models themselves 1114. It should be understood that the hybrid simulation engine 1104 could also be provided on a stand-alone computer for access by a user 1102.

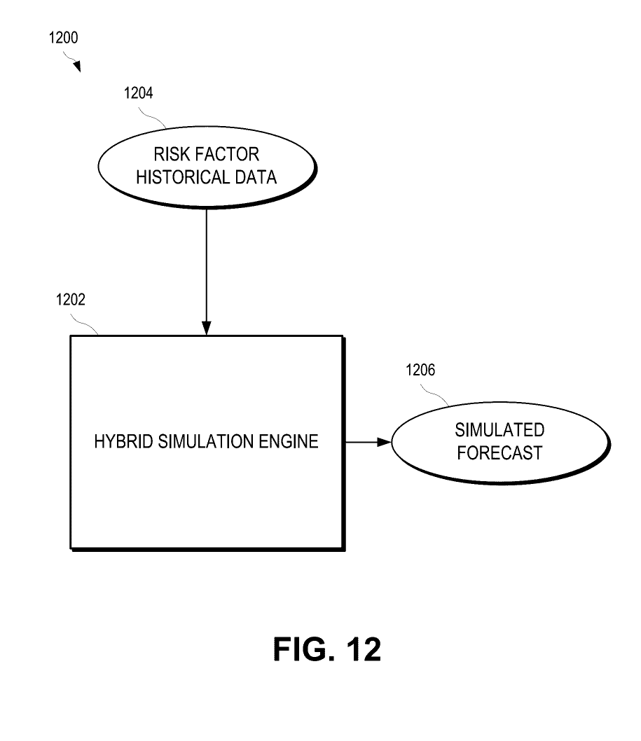

FIG. 12 is a block diagram 1200 depicting example inputs and outputs of a hybrid simulation engine. A hybrid simulation engine 1202 receives risk factor historical data 1204 as an input. For example, the hybrid simulation engine 1202 may receive historical time-series data for each of the plurality of risk factor variables to be simulated. The plurality of risk factors are grouped into a plurality of subgroups, and the risk factors may then be simulated using different simulation techniques to generated a simulated forecast 1206 for all or a portion of the risk factor variables for which historical data 1204 is received. A simulated forecast 1206 for a risk factor variable may be a single value, a forecast of a most-likely value, a set of simulated values, a distribution of simulated values, or some other representation of future values of a risk factor variable identified by the hybrid simulation engine 1202. The simulated forecast values 1206 for the risk factor variables may be useful as output in themselves, or they may be utilized in projecting values of other variables based on the simulated forecast values. For example, a projected stock price may be calculated based on simulated forecast values for related risk factors such as interest rates, exchange rates, as well as other risk factor variables.

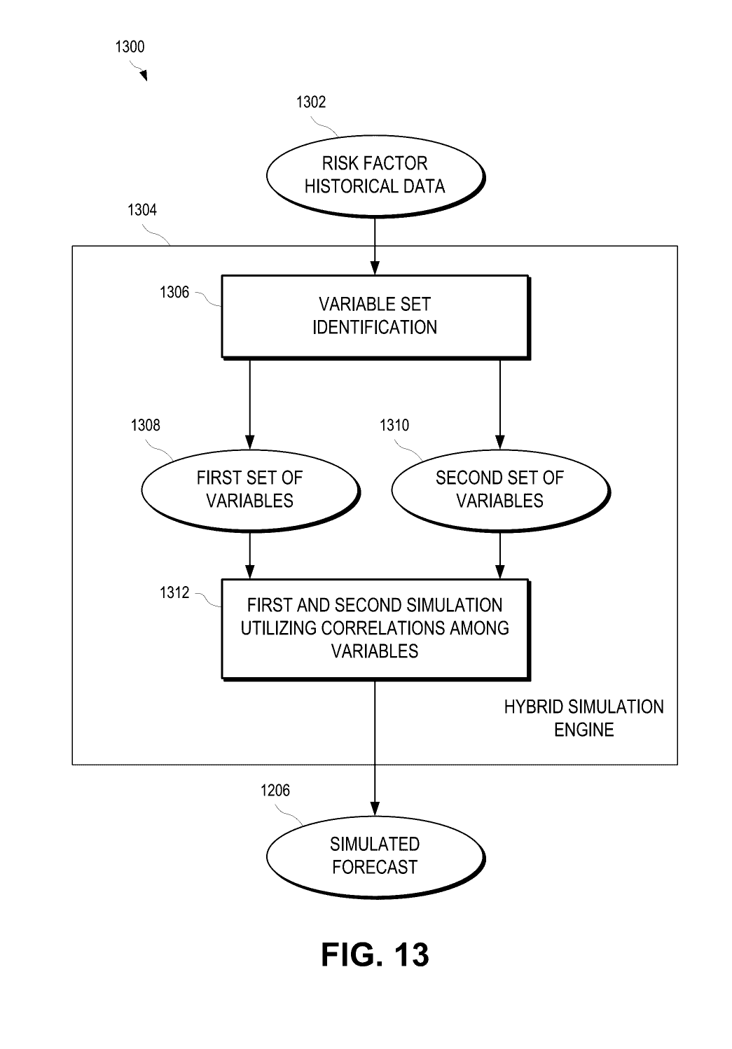

FIG. 13 is a flow diagram 1300 depicting a hybrid simulation process. Risk factor historical data 1302, such as time-series data representative of past data for each risk factor, is received by the hybrid simulation engine. A variable set identification 1306 divides the risk factors into two or more subgroups for further processing. The dividing of the risk factors into subgroups may be a manual process via input by a user or may be an automated process. The variable set identification 1306 identifies a first set of variables 1308 and a second set of variables 1310. The subgroups of variables are then simulated at 1312, where a first simulation method is applied to the first set of variables 1308 and a second simulation method is applied to the second set of variables 1310 while correlations among variables in both of the groups are maintained across the two different simulation methods. This process may be expanded to handle more than two subgroups where each additional subgroup of risk factors is simulated using a simulation method designated for that additional subgroup. For example, a third set of variables and a fourth set of variables may be identified by a variable set identification 1306, and the third set of variables and the fourth set of variables may be simulated using a third simulation and a fourth simulation method, respectively. The simulated values for the input risk factors are output from the hybrid simulation engine 1304 as a simulated forecast 1314.

For example, historical time-series data for a set of risk factors, V1, V2, V3 and V4, may be received at 1302. An automated variable set identification at 1306 may determine that risk factors V1 and V3 have a high degree of information contribution, while risk factors V2 and V4 have a lesser degree of information contribution. Based on that determination, risk factors V1 and V3 may be identified as the first set of variables (“the priority set of variables”) while risk factors V2 and V4 are identified as the second set of variables (“the non-priority set of variables”). Because the priority set of variables has a high degree of information contribution, it may be desired to use a more expensive simulation method, such as a Monte Carlo simulation, to simulate those variables. While the non-priority set of variables may contribute less information, it may still be desirable to simulate those variables to maintain dependencies and correlations between non-priority set members and priority set members. Thus, the non-priority set of variables may be simulated using a less computation intensive simulation method such as a covariate simulation. The simulated outputs from the two different simulation techniques may then be output as a simulated forecast at 1314.

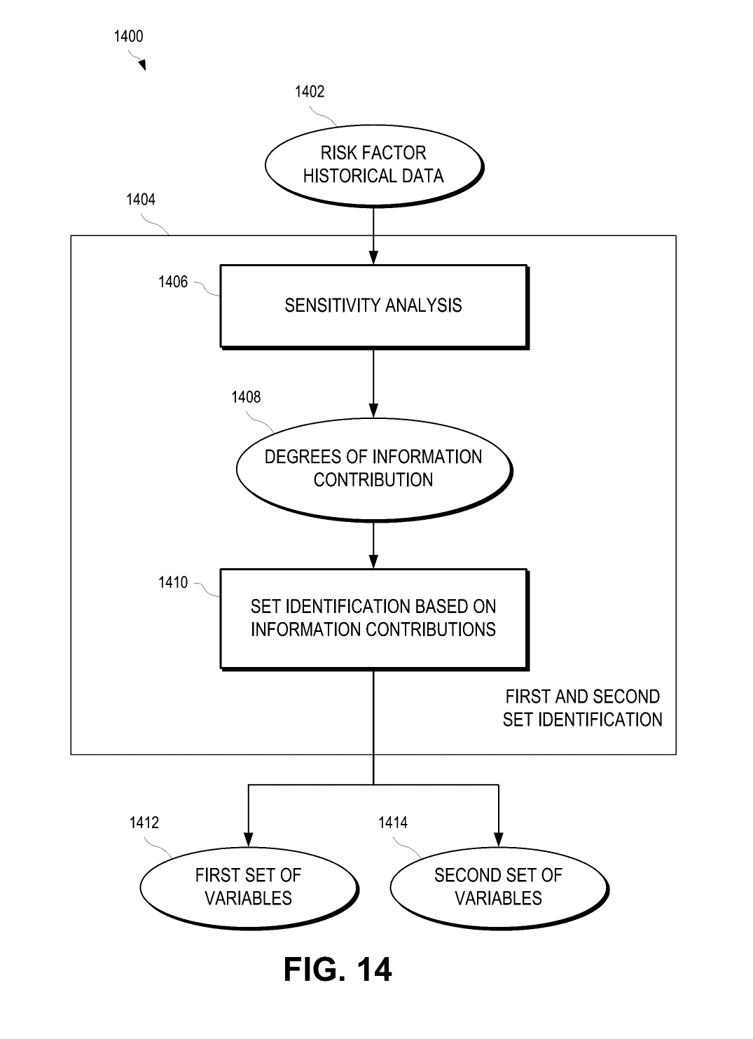

FIG. 14 is a flow diagram 1400 depicting an automated identification of risk factor subgroups. Risk factor historical data 1402 is received for first and second set identification 1404. A sensitivity analysis 1406 is performed on the risk factor historical data 1402 to identify an amount of information contribution 1408 present in each risk factor variable. A set identification 1410 is then performed based on the identified degrees of information contribution of the risk factor variables to identify a first set of variables 1412 and second set of variables 1414, as well as additional sets of variables where more than two subgroups are to be simulated. For example, risk factor variables having a high degree of information contribution may be identified as being members of a “priority” first set of variables 1412, while risk factor variables having a low degree of information contribution may be identified as being members of a “non-priority” second set of variables 1414.

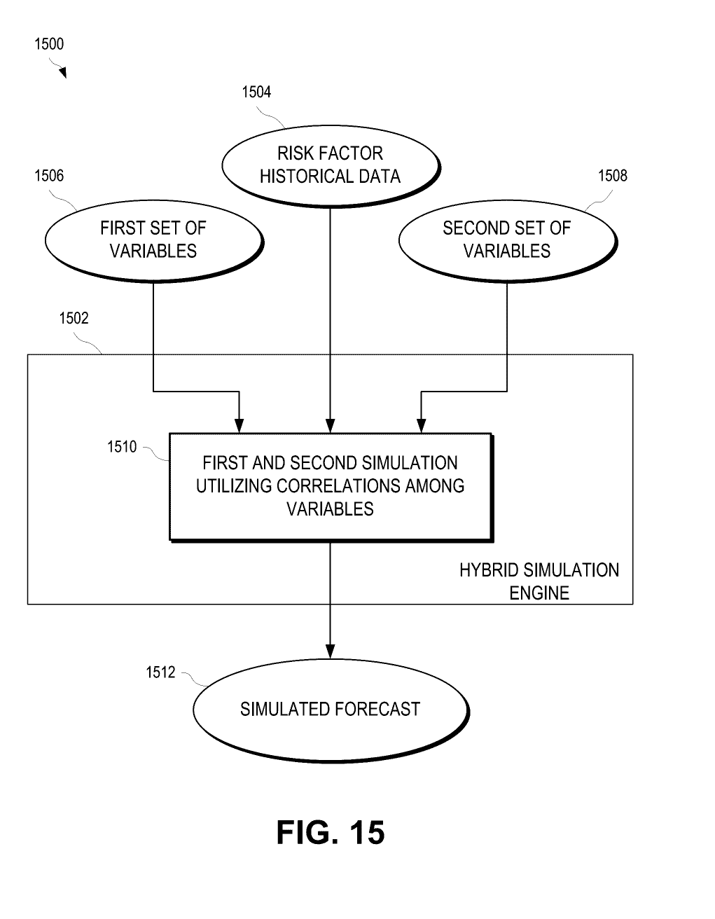

FIG. 15 is a flow diagram depicting a hybrid simulation process 1500 where the variable set identification is a manual process dictated by user or other external process input. The hybrid simulation engine 1502 receives risk factor historical data 1504 as well as definitions of which risk factors are in the first set of variables 1506 and which are in the second set of variables 1508. Upon receiving these inputs the hybrid simulation engine 1502 performs first and second simulations 1510 on the first set of variables 1506 and the second set of variables 1508, respectively, where the simulations are of different types may maintain correlations among the variables in the different sets of variables. The multiple simulations may differ in type by one or more of: the data model used, the number of historical time periods considered for a risk factor variable, complexity of the mathematical model, the amount of specification required, the source of input data, data differences required by regulatory, internal, or other policies, as well as other differences. The forecast values from the simulations performed at 1510 for the one or more of the risk factor variables are output as a simulated forecast 1512.

As an example, in a large risk management system, there may be different expectations of historical data for simulation analyses. For example, in Basel II (2004), banks are required to use at least five years of data to estimate the probability of defaults from external, internal, or pooled data sources. For loss given default and exposure at default, the minimum data observation period should be seven years. However, if the available observation period for one of these data sources spans a longer period for any other sources and that data is relevant and material, the longer period must be used according to the requirement of Basel II. Such a requirement results in a different length of historical data for different groups of risk factors within the single risk management system. The hybrid simulation engine 1502 may handle such a scenario by receiving variable set data dividing the risk factors into subgroups according to the length of available historical data. A proper simulation method is applied to each subgroup of risk factors based on the length of available historical data to be used, and simulated forecast values for the risk factors may be output while maintaining correlations among the risk factors in different subgroups.

Maintaining correlations among risk factors in different subgroups may be important for generating accurate forecasts in some scenarios. For a large risk management system, different risk factors, due to their source and modeling expectations may require different simulation models and may not be implemented in one single simulation. Some risk factors may require model based simulation; the others may require empirical historical simulation. A hybrid simulation combines different simulation methods in one single simulation run in order to generate an aggregated scenario of the world. When risk factors are modeled marginally within each subgroup, a correlation structure is oftentimes desired on top of the groups in order to capture of the dependency among different risk factors.

For example, for a collateralized debt obligation (CDO), it is important to understand the correlated dependency among the underlying entities in the CDO pool in addition to the risk characteristics of the each individual entity. One lesson learned through recent financial crises is that a risk management system should not segregate the risk factors because the dependency greatly affects the outcome of simulated results. Using CDOs as an example, the senior tranche (the safest portion of a CDO) benefits from a low correlation of the underlying entities in the pool, while the equity tranche (the least protected portion of a CDO) benefits from a high correlation. The correlation of the housing market to these tranches has often been significantly understated by analysts. Considering this correlation, the safest portion of the CDOs (e.g. a AAA rated senior tranche of mortgage backed security) actually suffers much bigger losses than expected without maintenance of the correlation. Ignoring the correlation has caused many financial institutions which either hold such “safe” investments or provide protection to some of the CDO tranches to fail.

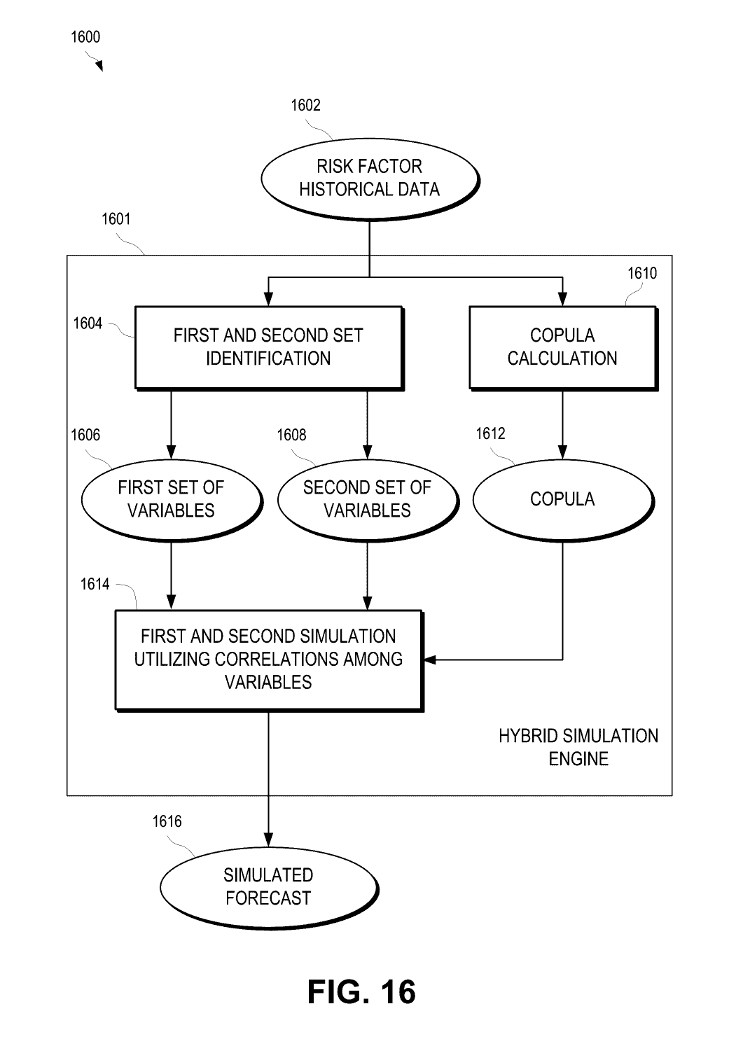

FIG. 16 is a flow diagram 1600 depicting a hybrid simulation engine that maintains correlations among risk factors in different subgroups using a copula. A hybrid simulation engine 1601 receives risk factor historical data 1602. A first and second set identification is performed at 1604 to identify a plurality of subgroups of variables, such as a first set of variables 1606 and a second set of variables 1608. Additionally, the risk factor historical data 1602 is utilized to perform a copula calculation 1610 to generate a copula data structure 1612 that is used to maintain correlations among the risk factor variables.

A copula is a mathematical framework that enables the separation of the correlation of a system of variables based on a marginal distribution of the variables. A copula may be a multivariate distribution having uniformly distributed values over (0,1) inclusively. For an n-dimensional random vector U on the unit cube, a copula C is:

C(u₁,u₂, . . . ,u_{N})=Pr(U₁≦u₁,U₂≦u₂, . . . ,Uₙ≦uₙ),

where Pr is a probability. A normal copula may be defined according to:

C_{ΣF}_{₁}_{,F}_{₂}_{, . . . ,F}_{_{N}}(u₁,u₂, . . . u_{N})=Φ_{Σ}(F₁⁻¹(u₁)F₂⁻¹(u₂), . . . ,F_{N}⁻¹(u_{N})),

where Fₙ is the marginal distribution for risk factor input variable n;

where Σ is a matrix representing the received correlation data indicative of correlations among the members of the pool of risk factor input variables;

where Φ_{Σ} is a standardized multivariate normal distribution with correlation matrix Σ; and

where uₙ is uniform data for risk factor input variable n.

Additional details of the properties of a Copula are described in Nelson, “An Introduction to Copulas,” Springer, 2006, the entirety of which is herein incorporated by reference. First and second simulations are performed on the first set of variables 1606 and the second set of variables 1608, respectively, using the copula 1612 to maintain correlations among the risk factor variables at 1614. The simulated forecast values 1616 are then output from the hybrid simulation engine 1601.

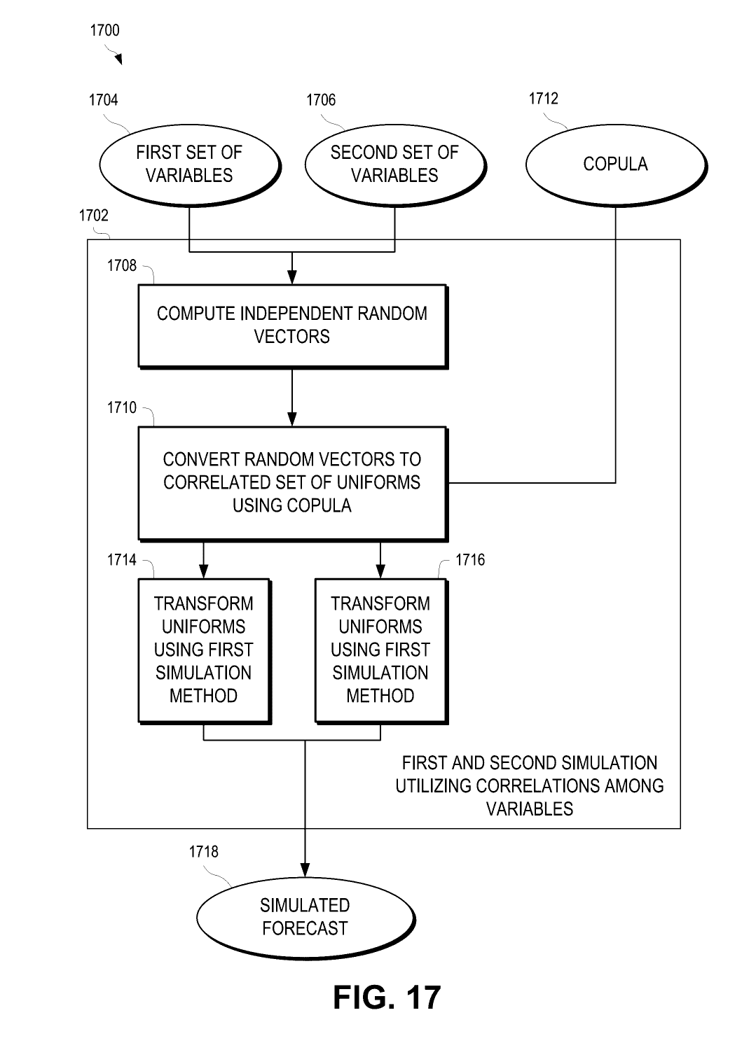

FIG. 17 is a flow diagram 1700 depicting a generation of a simulated forecast using a hybrid simulation engine that utilizes a copula to maintain correlations among variables. The first and second simulation 1702 receives a first set of variables 1704 and a second set of variables 1706. The first and second simulations 1702 compute independent random vectors at 1708. For example, for an iteration of a Monte Carlo simulation of a subgroup of risk factor variables, a random number for each risk factor variable in a subgroup is generated and inserted into a random vector for the associated simulation. At 1710, the random vectors are converted to a correlated set of uniforms using a received copula 1712. Correlated uniforms may be calculated by:

calculating a Cholesky decomposition of Σ, as A;

where Σ identifies correlations among risk factor variables;

simulating n independent random variates z=(z₁, z₂, . . . , zₙ) from N(0,1).

defining x as Az; and

calculating uᵢ=Φ(xᵢ) for I=1, 2, . . . , n, where Φ is a univariate standard normal distribution function.

The uniforms are then transformed to marginal distributions based on the different simulation methods, as shown at 1714, 1716 where uniforms are transformed using the first simulation method at 1714 and uniforms are transformed using a second simulation method at 1716. Generating a first simulation and generating a second simulation may include generating a conditional normal distribution for a dependent set of risk factors variables in the first set of variables using a Schur complement based on correlations among members of the pool of input risk factor variables. The simulated forecasts 1718 are then output from the simulated forecast.

An example hybrid simulation utilizing a conditional normal approach and the same example utilizing a copula approach are provided below. The example scenario contains two subgroups of risk factors. The first set of risk factor variables contains variables that that are modeled using the log return of equity prices that follow a random walk. That is, normally distributed draws are made that represent changes in the return process:

return_{i,t}=return_{i,t-1}+ε_{i,t}, where

ε_{i,t}=σᵣₑₜᵤᵣₙ_{ᵢ}*e_{i,t}, where

e_{i,t}˜Normal(0,1)

The second set of variables contains only one risk factor, a spot interest rate, which is modeled as a CIR (Cos-Ingersoll-Ross) model. The formula for this model is:

rateₜ=rateₜ₋₁+κ*(θ−rateₜ₋₁)+δₜ, where

δₜ=σᵣₐₜₑ*\sqrt{rateₜ₋₁}*ξₜ, where

ξₜ˜Normal(0,1)

In addition to the two models provided above, the two risk factors are related through the two error terms, as represented by the covariance matrix, Σ:

$$Σ = [ \begin{matrix}1 & 0.5 & - 0.2 \\ 0.5 & 1 & - 0.1 \\ - 0.2 & - 0.1 & 1\end{matrix} ] .$$

Converting independent random vectors to a correlated set of uniforms may utilize a Cholesky factorization of the covariance matrix. A Cholesky factorization is defined as:

Σ=LL^{T},

where L is a lower triangular matrix. For the sample covariance matrix above:

$$L = [ \begin{matrix}1 & 0 & 0 \\ 0.5 & 0.866 & 0 \\ - 0.2 & 0 & - 0.980\end{matrix} ] .$$

A multivariate normal distribution may then be simulated using the following steps:

(M1) Draw samples independently from normal(0,1). In the example scenario, three values are drawn in each scenario replication:

$$R = [ \begin{matrix}{r}_{1} \\ {r}_{2} \\ {r}_{3}\end{matrix} ] .$$

(M2) Transform the independent random draws to a correlated draw using the Cholesky factor: Z=L^{T}*R.
(M3) Apply Z for the error terms in the model.
The target variable in this case could be the price of a basket option of the two equities. The price of this basket option is a function of the two return processes and the rate process:

pₜ=ƒ(return_{1,t},return_{2,t},rateₜ).

The hybrid simulation may be performed via multiple different approaches. For example, using a conditional normal distribution using standard statistical result, the rate process may be identified by a priority risk factor and may be simulated using a Monte Carlo simulation, while the return processes may be identified as non-priority risk factors simulated using a covariance simulation. Conditional on the realization of the rate process, the error terms of the covariance simulations may be a simulation from a conditional normal (for each ξₜ=x) with the conditional mean and conditional variance for the return process error terms according to:

$${μ}_{ε \vert {ξ}_{t} = x} = [ \begin{matrix}- 0.2 \\ - 0.1\end{matrix} ] * x$$

$${Σ}_{{ξ}_{t} = x} = [ \begin{matrix}1 & 0.5 \\ 0.5 & 1\end{matrix} ] - [ \begin{matrix}- 0.2 \\ - 0.1\end{matrix} ] [ \begin{matrix}- 0.2 & - 0.1\end{matrix} ] = [ \begin{matrix}0.96 & 0.48 \\ 0.48 & 0.99\end{matrix} ] ,$$

followed by an application of (M1)-(M3) in the conditional bi-variate normal distribution defined above. The three risk factors are simulated within the same system to generate the forecasted distribution for the target variables.

As another example, using a copula approach, the distribution of each risk factor variable may be computed. These distributions may have a functional form. However, simulated distribution or empirical distribution calculation may also be performed. A simulation may then be performed from a multivariate distribution according to (M1)-(M3). Using the marginal distribution of each process, the simulated values from the multivariate normal may be converted to form a vector of random values ranging from 0 to 1. Using the inverse cumulative distribution function that corresponds to each marginal distribution computed, the converted simulated value may be transformed to generate a simulated value for each risk factor variable.

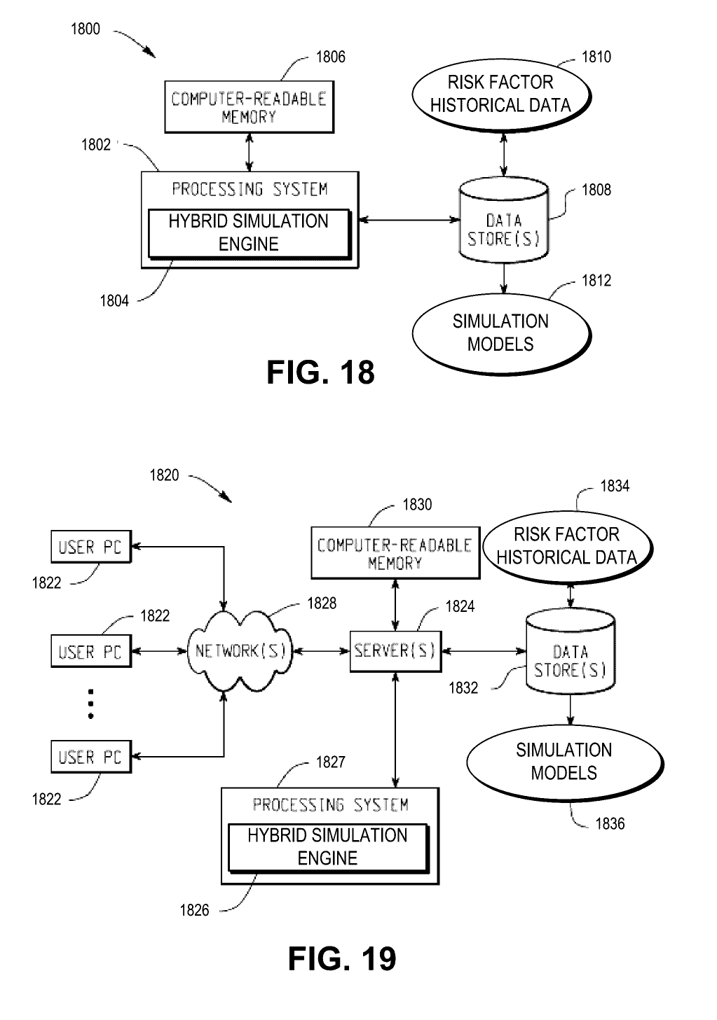

FIGS. 18, 19, and 20 depict example systems for use in implementing a hybrid simulation engine 1804. For example, FIG. 18 depicts an exemplary system 1800 that includes a stand alone computer architecture where a processing system 1802 (e.g., one or more computer processors) includes a hybrid simulation engine 1804 being executed on it. The processing system 1802 has access to a computer-readable memory 1806 in addition to one or more data stores 1808. The one or more data stores 1808 may contain risk factor historical data 1810, also known as past data, as well as simulation models 1812.

FIG. 19 depicts a system 1820 that includes a client server architecture. One or more user PCs 1822 accesses one or more servers 1824 running a hybrid simulation engine 1826 on a processing system 1827 via one or more networks 1828. The one or more servers 1824 may access a computer readable memory 1830 as well as one or more data stores 1832. The one or more data stores 1832 may contain risk factor historical data 1834 as well as simulation models 1836.

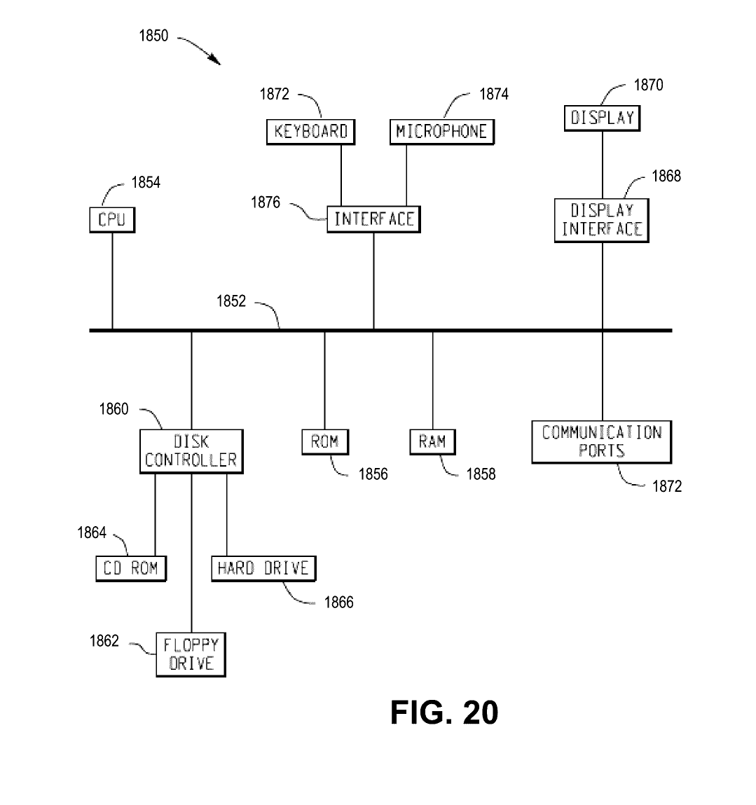

FIG. 20 shows a block diagram of exemplary hardware for a stand alone computer architecture 1850, such as the architecture depicted in FIG. 18, that may be used to contain and/or implement the program instructions of system embodiments of the present invention. A bus 1852 may serve as the information highway interconnecting the other illustrated components of the hardware. A processing system 1854 labeled CPU (central processing unit) (e.g., one or more computer processors), may perform calculations and logic operations required to execute a program. A processor-readable storage medium, such as read only memory (ROM) 1856 and random access memory (RAM) 1858, may be in communication with the processing system 1854 and may contain one or more programming instructions for performing the method of implementing a hybrid simulation engine. Optionally, program instructions may be stored on a computer readable storage medium such as a magnetic disk, optical disk, recordable memory device, flash memory, or other physical storage medium. Computer instructions may also be communicated via a communications signal, or a modulated carrier wave.

A disk controller 1860 interfaces one or more optional disk drives to the system bus 1852. These disk drives may be external or internal floppy disk drives such as 1862, external or internal CD-ROM, CD-R, CD-RW or DVD drives such as 1864, or external or internal hard drives 1866. As indicated previously, these various disk drives and disk controllers are optional devices.

Each of the element managers, real-time data buffer, conveyors, file input processor, database index shared access memory loader, reference data buffer and data managers may include a software application stored in one or more of the disk drives connected to the disk controller 1860, the ROM 1856 and/or the RAM 1858. Preferably, the processor 1854 may access each component as required.

A display interface 1868 may permit information from the bus 1856 to be displayed on a display 1870 in audio, graphic, or alphanumeric format. Communication with external devices may optionally occur using various communication ports 1873.

In addition to the standard computer-type components, the hardware may also include data input devices, such as a keyboard 1872, or other input device 1874, such as a microphone, remote control, pointer, mouse and/or joystick.

As used below, any reference to a series of examples is to be understood as a reference to each of those examples disjunctively (e.g., “Examples 1-4” is to be understood as “Examples 1, 2, 3, or 4”).

Example 1 is a computer-implemented system, comprising one or more data processors and one or more non transitory computer-readable storage media containing instructions configured to cause the one or more processors to perform operations including accessing past data including multiple variables, wherein the one or more data processors include a hybrid simulation engine; automatically identifying a priority set of variables, wherein the priority set includes one or more of the multiple variables having a first degree of information contribution; automatically identifying a non-priority set of variables, wherein the non-priority set includes one or more of the multiple variables having a second degree of information contribution that is lesser than the first degree of information contribution; producing a copula data structure using the past data, wherein the copula data structure is used to maintain correlations among the multiple variables, and wherein producing the copula data structure includes performing a copula calculation using the past data; calculating a set of priority simulated values for one or more variables of the priority set, wherein calculating includes using a first simulation technique and the copula data structure, and wherein the first simulation technique results in a first computational expense to the one or more data processors processing the one or more variables of the priority set; calculating a set of non-priority simulated values for one or more variables of the non-priority set, wherein calculating includes using a second simulation technique and the copula data structure, wherein the second simulation technique results in a second computational expense to the one or more data processors processing the one or more variables of the non-priority set, and wherein the second computational expense to the one or more data processors is less than the first computational expense to the one or more data processors; and producing a hybrid set of simulated values for the multiple variables using the hybrid simulation engine, wherein the hybrid simulation engine processes the priority simulated values and the non-priority simulated values on the hybrid simulation engine, and wherein producing the hybrid set of simulated values for the multiple variables concurrently prioritizes accuracy of the priority simulated values and reduces an overall computational expense to the one or more data processors.

Example 2 is the system of example 1, wherein automatically identifying the priority set of variables includes calculating the information contribution of the one or more variables of the priority set and calculating the information contribution of the one or more variables of the non-priority set.

Example 3 is the system of examples 1 or 2, wherein the first simulation technique includes a Monte Carlo simulation.

Example 4 is the system of examples 1-3, wherein the second simulation technique includes a covariate simulation.

Example 5 is the system of examples 1-4, wherein calculating a set of priority simulated values for one or more variables of the priority set further includes automatically selecting the set of priority simulated values based on the duration of an observation period corresponding to one or more of the variables of the priority set.

Example 6 is the system of examples 1-5, wherein calculating a set of priority simulated values for one or more variables of the priority set further includes computing independent random vectors; converting the independent random vectors to a correlated set of uniforms using the copula data structure; and transforming the uniforms into marginal distributions.

Example 7 is the system of example 6, wherein converting the independent random vectors to a correlated set of uniforms involves utilizing a Cholesky factorization of a covariance matrix.

Example 8 is the system of examples 1-7, wherein the past data associated with a variable of the priority set corresponds to a first observation period, and wherein the past data associated with a variable of the non-priority set corresponds to a second observation period, and wherein the second observation period is of a different duration than the first observation period.

Example 9 is the system of examples 1-8, wherein automatically identifying the priority set of variables is based on an amount of past data associated with one or more individual variables.

Example 10 is a computer-implemented method, comprising accessing, on a computing device, past data including multiple variables, wherein the computing device includes a hybrid simulation engine for producing hybrid forecasts using one or one or more data processors of the computing device; automatically identifying a priority set of variables, wherein the priority set includes one or more of the multiple variables having a first degree of information contribution; automatically identifying a non-priority set of variables, wherein the non-priority set includes one or more of the multiple variables having a second degree of information contribution that is lesser than the first degree of information contribution; producing a copula data structure using the past data, wherein the copula data structure is used to maintain correlations among the multiple variables, and wherein producing the copula data structure includes performing a copula calculation using the past data; calculating a set of priority simulated values for one or more variables of the priority set, wherein calculating includes using a first simulation technique and the copula data structure, and wherein the first simulation technique results in a first computational expense to the one or more data processors processing the one or more variables of the priority set; calculating a set of non-priority simulated values for one or more variables of the non-priority set, wherein calculating includes using a second simulation technique and the copula data structure, wherein the second simulation technique results in a second computational expense to the one or more data processors processing the one or more variables of the non-priority set, and wherein the second computational expense to the one or more data processors is less than the first computational expense to the one or more data processors; and producing a hybrid set of simulated values for the multiple variables using the hybrid simulation engine, wherein the hybrid simulation engine processes the priority simulated values and the non-priority simulated values on the hybrid simulation engine, and wherein producing the hybrid set of simulated values for the multiple variables concurrently prioritizes accuracy of the priority simulated values and reduces an overall computational expense to the one or more data processors.

Example 11 is the method of example 10, wherein automatically identifying the priority set of variables includes calculating the information contribution of the one or more variables of the priority set and calculating the information contribution of the one or more variables of the non-priority set.

Example 12 is the method of examples 10 or 11, wherein the first simulation technique includes a Monte Carlo simulation.

Example 13 is the method of examples 10-12, wherein the second simulation technique includes a covariate simulation.

Example 14 is the method of examples 10-13, wherein calculating a set of priority simulated values for one or more variables of the priority set further includes automatically selecting the set of priority simulated values based on the duration of an observation period corresponding to one or more of the variables of the priority set.

Example 15 is the method of examples 10-14, wherein calculating a set of priority simulated values for one or more variables of the priority set further includes: computing independent random vectors; converting the independent random vectors to a correlated set of uniforms using the copula data structure; and transforming the uniforms into marginal distributions.

Example 16 is the method of example 15, wherein converting the independent random vectors to a correlated set of uniforms involves utilizing a Cholesky factorization of a covariance matrix.

Example 17 is the method of examples 10-16, wherein the past data associated with a variable of the priority set corresponds to a first observation period, and wherein the past data associated with a variable of the non-priority set corresponds to a second observation period, and wherein the second observation period is of a different duration than the first observation period.

Example 18 is the method of examples 10-17, wherein automatically identifying the priority set of variables is based on an amount of past data associated with one or more individual variables.

Example 19 is a computer-program product tangibly embodied in a non-transitory machine-readable storage medium, including instructions configured to cause a data processing apparatus to perform operations including accessing past data including multiple variables, wherein the data processing apparatus includes a hybrid simulation engine for producing hybrid forecasts using one or more data processors of the data processing apparatus; automatically identifying a priority set of variables, wherein the priority set includes one or more of the multiple variables having a first degree of information contribution; automatically identifying a non-priority set of variables, wherein the non-priority set includes one or more of the multiple variables having a second degree of information contribution that is lesser than the first degree of information contribution; producing a copula data structure using the past data, wherein the copula data structure is used to maintain correlations among the multiple variables, and wherein producing the copula data structure includes performing a copula calculation using the past data; calculating a set of priority simulated values for one or more variables of the priority set, wherein calculating includes using a first simulation technique and the copula data structure, and wherein the first simulation technique results in a first computational expense to the one or more data processors processing the one or more variables of the priority set; calculating a set of non-priority simulated values for one or more variables of the non-priority set, wherein calculating includes using a second simulation technique and the copula data structure, wherein the second simulation technique results in a second computational expense to the one or more data processors processing the one or more variables of the non-priority set, and wherein the second computational expense to the one or more data processors is less than the first computational expense to the one or more data processors; and producing a hybrid set of simulated values for the multiple variables using the hybrid simulation engine, wherein the hybrid simulation engine processes the priority simulated values and the non-priority simulated values on the hybrid simulation engine, and wherein producing the hybrid set of simulated values for the multiple variables concurrently prioritizes accuracy of the priority simulated values and reduces an overall computational expense to the one or more data processors.

Example 20 is the computer-program product of example 19, wherein automatically identifying the priority set of variables includes calculating the information contribution of the one or more variables of the priority set and calculating the information contribution of the one or more variables of the non-priority set.

Example 21 is the computer-program product of examples 19 or 20, wherein the first simulation technique includes a Monte Carlo simulation.

Example 22 is the computer-program product of examples 19-21, wherein the second simulation technique includes a covariate simulation.

Example 23 is the computer-program product of examples 19-22, wherein calculating a set of priority simulated values for one or more variables of the priority set further includes automatically selecting the set of priority simulated values based on the duration of an observation period corresponding to one or more of the variables of the priority set.

Example 24 is the computer-program product of examples 19-23, wherein calculating a set of priority simulated values for one or more variables of the priority set further includes computing independent random vectors; converting the independent random vectors to a correlated set of uniforms using the copula data structure; and transforming the uniforms into marginal distributions.

Example 25 is the computer-program product of example 24, wherein converting the independent random vectors to a correlated set of uniforms involves utilizing a Cholesky factorization of a covariance matrix.

Example 26 is the computer-program product of examples 19-25, wherein the past data associated with a variable of the priority set corresponds to a first observation period, and wherein the past data associated with a variable of the non-priority set corresponds to a second observation period, and wherein the second observation period is of a different duration than the first observation period.

Example 27 is the computer-program product of examples 19-26, wherein automatically identifying the priority set of variables is based on an amount of past data associated with one or more individual variables.

What is claimed is:

1. A computer-implemented system, comprising:
one or more data processors; and
one or more non transitory computer-readable storage media containing instructions configured to cause the one or more processors to perform operations including:
accessing past data including multiple variables, wherein the one or more data processors include a hybrid simulation engine;
automatically identifying a priority set of variables, wherein the priority set includes one or more of the multiple variables having a first degree of information contribution;
automatically identifying a non-priority set of variables, wherein the non-priority set includes one or more of the multiple variables having a second degree of information contribution that is lesser than the first degree of information contribution;
producing a copula data structure using the past data, wherein the copula data structure is used to maintain correlations among the multiple variables, and wherein producing the copula data structure includes performing a copula calculation using the past data;
calculating a set of priority simulated values for one or more variables of the priority set, wherein calculating includes using a first simulation technique and the copula data structure, and wherein the first simulation technique results in a first computational expense to the one or more data processors processing the one or more variables of the priority set;
calculating a set of non-priority simulated values for one or more variables of the non-priority set, wherein calculating includes using a second simulation technique and the copula data structure, wherein the second simulation technique results in a second computational expense to the one or more data processors processing the one or more variables of the non-priority set, and wherein the second computational expense to the one or more data processors is less than the first computational expense to the one or more data processors; and
producing a hybrid set of simulated values for the multiple variables using the hybrid simulation engine, wherein the hybrid simulation engine processes the priority simulated values and the non-priority simulated values on the hybrid simulation engine, and wherein producing the hybrid set of simulated values for the multiple variables concurrently prioritizes accuracy of the priority simulated values and reduces an overall computational expense to the one or more data processors.

2. The system of claim 1, wherein automatically identifying the priority set of variables includes calculating the information contribution of the one or more variables of the priority set and calculating the information contribution of the one or more variables of the non-priority set.

3. The system of claim 1, wherein the first simulation technique includes a Monte Carlo simulation.

4. The system of claim 1, wherein the second simulation technique includes a covariate simulation.

5. The system of claim 1, wherein calculating a set of priority simulated values for one or more variables of the priority set further includes automatically selecting the set of priority simulated values based on the duration of an observation period corresponding to one or more of the variables of the priority set.

6. The system of claim 1, wherein calculating a set of priority simulated values for one or more variables of the priority set further includes:
computing independent random vectors;
converting the independent random vectors to a correlated set of uniforms using the copula data structure; and
transforming the uniforms into marginal distributions.

7. The system of claim 6, wherein converting the independent random vectors to a correlated set of uniforms involves utilizing a Cholesky factorization of a covariance matrix.

8. The system of claim 1, wherein the past data associated with a variable of the priority set corresponds to a first observation period, and wherein the past data associated with a variable of the non-priority set corresponds to a second observation period, and wherein the second observation period is of a different duration than the first observation period.

9. The system of claim 1, wherein automatically identifying the priority set of variables is based on an amount of past data associated with one or more individual variables.

10. A computer-implemented method, comprising:
accessing, on a computing device, past data including multiple variables, wherein the computing device includes a hybrid simulation engine for producing hybrid forecasts using one or one or more data processors of the computing device;
automatically identifying a priority set of variables, wherein the priority set includes one or more of the multiple variables having a first degree of information contribution;
automatically identifying a non-priority set of variables, wherein the non-priority set includes one or more of the multiple variables having a second degree of information contribution that is lesser than the first degree of information contribution;
producing a copula data structure using the past data, wherein the copula data structure is used to maintain correlations among the multiple variables, and wherein producing the copula data structure includes performing a copula calculation using the past data;
calculating a set of priority simulated values for one or more variables of the priority set, wherein calculating includes using a first simulation technique and the copula data structure, and wherein the first simulation technique results in a first computational expense to the one or more data processors processing the one or more variables of the priority set;
calculating a set of non-priority simulated values for one or more variables of the non-priority set, wherein calculating includes using a second simulation technique and the copula data structure, wherein the second simulation technique results in a second computational expense to the one or more data processors processing the one or more variables of the non-priority set, and wherein the second computational expense to the one or more data processors is less than the first computational expense to the one or more data processors; and
producing a hybrid set of simulated values for the multiple variables using the hybrid simulation engine, wherein the hybrid simulation engine processes the priority simulated values and the non-priority simulated values on the hybrid simulation engine, and wherein producing the hybrid set of simulated values for the multiple variables concurrently prioritizes accuracy of the priority simulated values and reduces an overall computational expense to the one or more data processors.

11. The method of claim 10, wherein automatically identifying the priority set of variables includes calculating the information contribution of the one or more variables of the priority set and calculating the information contribution of the one or more variables of the non-priority set.

12. The method of claim 10, wherein the first simulation technique includes a Monte Carlo simulation.

13. The method of claim 10, wherein the second simulation technique includes a covariate simulation.

14. The method of claim 10, wherein calculating a set of priority simulated values for one or more variables of the priority set further includes automatically selecting the set of priority simulated values based on the duration of an observation period corresponding to one or more of the variables of the priority set.

15. The method of claim 10, wherein calculating a set of priority simulated values for one or more variables of the priority set further includes:
computing independent random vectors;
converting the independent random vectors to a correlated set of uniforms using the copula data structure; and
transforming the uniforms into marginal distributions.

16. The method of claim 15, wherein converting the independent random vectors to a correlated set of uniforms involves utilizing a Cholesky factorization of a covariance matrix.

17. The method of claim 10, wherein the past data associated with a variable of the priority set corresponds to a first observation period, and wherein the past data associated with a variable of the non-priority set corresponds to a second observation period, and wherein the second observation period is of a different duration than the first observation period.

18. The method of claim 10, wherein automatically identifying the priority set of variables is based on an amount of past data associated with one or more individual variables.

19. A computer-program product tangibly embodied in a non-transitory machine-readable storage medium, including instructions configured to cause a data processing apparatus to perform operations including:
accessing past data including multiple variables, wherein the data processing apparatus includes a hybrid simulation engine for producing hybrid forecasts using one or more data processors of the data processing apparatus;
automatically identifying a priority set of variables, wherein the priority set includes one or more of the multiple variables having a first degree of information contribution;
automatically identifying a non-priority set of variables, wherein the non-priority set includes one or more of the multiple variables having a second degree of information contribution that is lesser than the first degree of information contribution;
producing a copula data structure using the past data, wherein the copula data structure is used to maintain correlations among the multiple variables, and wherein producing the copula data structure includes performing a copula calculation using the past data;
calculating a set of priority simulated values for one or more variables of the priority set, wherein calculating includes using a first simulation technique and the copula data structure, and wherein the first simulation technique results in a first computational expense to the one or more data processors processing the one or more variables of the priority set;
calculating a set of non-priority simulated values for one or more variables of the non-priority set, wherein calculating includes using a second simulation technique and the copula data structure, wherein the second simulation technique results in a second computational expense to the one or more data processors processing the one or more variables of the non-priority set, and wherein the second computational expense to the one or more data processors is less than the first computational expense to the one or more data processors; and
producing a hybrid set of simulated values for the multiple variables using the hybrid simulation engine, wherein the hybrid simulation engine processes the priority simulated values and the non-priority simulated values on the hybrid simulation engine, and wherein producing the hybrid set of simulated values for the multiple variables concurrently prioritizes accuracy of the priority simulated values and reduces an overall computational expense to the one or more data processors.

20. The computer-program product of claim 19, wherein automatically identifying the priority set of variables includes calculating the information contribution of the one or more variables of the priority set and calculating the information contribution of the one or more variables of the non-priority set.

21. The computer-program product of claim 19, wherein the first simulation technique includes a Monte Carlo simulation.

22. The computer-program product of claim 19, wherein the second simulation technique includes a covariate simulation.

23. The computer-program product of claim 19, wherein calculating a set of priority simulated values for one or more variables of the priority set further includes automatically selecting the set of priority simulated values based on the duration of an observation period corresponding to one or more of the variables of the priority set.

24. The computer-program product of claim 19, wherein calculating a set of priority simulated values for one or more variables of the priority set further includes:
computing independent random vectors;
converting the independent random vectors to a correlated set of uniforms using the copula data structure; and
transforming the uniforms into marginal distributions.

25. The computer-program product of claim 24, wherein converting the independent random vectors to a correlated set of uniforms involves utilizing a Cholesky factorization of a covariance matrix.

26. The computer-program product of claim 19, wherein the past data associated with a variable of the priority set corresponds to a first observation period, and wherein the past data associated with a variable of the non-priority set corresponds to a second observation period, and wherein the second observation period is of a different duration than the first observation period.

27. The computer-program product of claim 19, wherein automatically identifying the priority set of variables is based on an amount of past data associated with one or more individual variables.
